(19) United States
(12) Patent Application Publication
(10) Pub. No.: US 2026/0100894 A1
(43) Pub. Date: Apr. 9, 2026

(54) DIFFERENTIAL TRANSMISSION OF QOE REPORTS AND RVQOE REPORTS

(71) Applicant: Telefonaktiebolaget LM Ericsson (publ), Stockholm (SE)

(72) Inventors: Cecilia Eklöf, Täby (SE); Johan Rune, Lidingö (SE); Filip Barac, Huddinge (SE); Luca Lunardi, Genova (SE); Mattias Bergström, Sollentuna (SE); Agne Ciuciulkaite, Uppsala (SE)

(21) Appl. No.: 19/115,278

(22) PCT Filed: Oct. 23, 2023
(86) PCT No.: PCT/SE2023/051046

§ 371 Date: Mar. 26, 2025

Related U.S. Application Data
(60) Provisional application No. 63/420,337, filed on Oct. 28, 2022.

(51) Int. Cl. H04L 41/5067; H04W 24/10

(52) U.S. Cl. CPC H04L 41/5067; H04W 24/10

(57) ABSTRACT

Systems and methods related to Quality of Experience (QoE) and Radio Access Network (RAN) Visible QoE (RVQoE) measurement and reporting are disclosed. In one embodiment, a method performed by a User Equipment (UE) comprises receiving, from one or more network nodes, one or more messages comprising one or more QoE configurations and one or more RVQoE configurations. The method further comprises, for each QoE configuration or commonly for the one or more QoE configurations, receiving an indication that indicates a network node to which respective QoE reports are to be sent and, for each RVQoE configuration or commonly for the one or more RVQoE configurations, receiving an indication that indicates a network node to which respective RVQoE reports are to be sent. The method further comprises performing QoE measurements and RVQoE measurements and sending corresponding QoE and RVQoE reports in accordance with the received indications.

### RELATED APPLICATIONS

This application claims the benefit of provisional patent application Ser. No. 63/420,337, filed Oct. 28, 2022, the disclosure of which is hereby incorporated herein by reference in its entirety.

### TECHNICAL FIELD

The present disclosure relates to Quality of Experience (QoE) and Radio Access Network (RAN)-Visible QoE (RVQoE) reporting in a cellular communications system.

### BACKGROUND

### Overview of the QoE Framework and “Regular QoE”

Quality of Experience (QoE) measurements, also referred to as “application layer measurements”, have been specified for 3^{rd} Generation Partnership Project (3GPP) Long Term Evolution (LTE) and the Universal Mobile Telecommunications System (UMTS) and for New Radio (NR) in 3GPP release 17. The purpose of the application layer measurements is to measure the end user experience when using certain applications. QoE measurements for streaming services and for Mobility Telephony Service for Internet Protocol (IP) Multimedia Subsystem (IMS) (MTSI) services are supported in LTE and UMTS and, for NR, Virtual Reality (VR) is also supported.

The solutions for regular QoE are similar in NR, LTE, and UMTS with the overall principles as follows. Quality of Experience Measurement Collection (QMC) enables configuration of application layer measurements in the User Equipment (UE) and transmission of QoE measurement result files (commonly referred to as QoE reports) to the network by means of Radio Resource Control (RRC) signaling. An application layer measurement configuration (also called QoE measurement configuration or QoE configuration) that the Radio Access Network (RAN) receives from the Operations, Administration, and Maintenance (OAM) system or the Core Network (CN) is encapsulated in a transparent container, which is forwarded to a UE in a downlink RRC message. An application layer measurement report (also called QoE report) that the UE Access Stratum (UE AS) or UE RRC layer receives from the UE's higher layer (application layer) is encapsulated in a transparent container and sent to the network in an uplink RRC message. The RAN then forwards the QoE report to a Measurement Collector Entity (MCE).

The configuration data related to QoE measurements (in standard specifications typically referred to as application layer measurements) is received by the base station (e.g., the next generation Node B (gNB) for NR) from OAM and consists of a service type indication, an indication of an area in which the measurements are to be performed (denoted area scope), an IP address of the entity the collected measurement results (i.e. the QoE reports) should be sent to (often referred to as a MCE, spelled out as Measurement Collector Entity or Measurement Collection Entity, but the entity may sometimes also be referred to as a Trace Collection Entity), and a set of instructions of which type of measurements should be performed and details of how these measurements are to be performed. These instructions are intended for the application layer in the UE and are placed in a “container” which the network entities handling it, e.g., forwarding it to the UE, as well as the UE Access Stratum, cannot interpret and do not try to read.

The container is forwarded to the UE in RRC signaling together with the indicated service type. For measurements in RRC_CONNECTED, the area is kept in the base station (e.g., gNB in the case of NR), and the network ensures that the UE measures in the correct area by configuring the UE when to start and stop the measurements. The area scope is defined in terms of cells or network related areas. In UMTS, an area scope is defined as either a list of cells, a list of routing areas, or a list of tracking areas. In LTE and NR, an area scope is defined as either a list of cells or a list of tracking areas.

QoE, and in particular QoE configuration, comes in two flavors: management-based QoE configuration and signaling-based QoE configuration. In both cases, the QoE configuration originates in the OAM system or some other administrational entity, e.g., dealing with customer satisfaction. All of these entities are referred to herein as the OAM system (where the OAM system also contains further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (s-based QoE), the OAM system is interested in collecting QoE measurement results from a specific UE, e.g., because the user of the UE has filed a complaint. The OAM system sends the s-based QoE configuration to the Home Subscriber Server (HSS) (in the Evolved Packet System (EPS)/LTE) or Unified Data Management (UDM) (in the 5^{th} Generation System (5GS)/NR), which forwards the QoE configuration to the UE's current core network (CN) node, e.g. a Mobility Management Entity (MME) in EPS/LTE or an Access and Mobility Management Function (AMF) in 5G/NR. The CN then forwards the s-based QoE configuration to the RAN node that serves the concerned UE, and the RAN node forwards it to the UE.

The service type indication and the container with the measurement instructions are forwarded to the UE. The UE is not aware of whether a received QoE configuration is m-based or s-based. In legacy systems, the QoE framework is integrated with the Trace functionality, and a Trace Identity (ID) is associated with each QoE configuration. In NR, the QoE functionality is logically separated from the Trace functionality, but it will still partly reuse the Trace signaling mechanisms. In NR and LTE, a globally unique QoE reference (formed of Mobile Country Code (MCC)+Mobile Network Code (MNC)+QMC ID, where the QMC ID is a string of 24 bits) will be associated with each QoE configuration. The QoE reference is included in the container with measurement instructions and also sent to the RAN (e.g., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE measurement results (QoE reports) are sent from the UE application layer to the UE Access Stratum, which forwards them to the RAN, which forwards them to the MCE. These QoE measurement results are placed in a “container”, which is uninterpretable for the UE Access Stratum and the RAN. QoE reporting can be configured to be periodic or only sent at the end of an application session. Furthermore, the RAN can instruct the UE to pause QoE reporting, e.g. in case the cell/gNB is in a state of overload.

The RAN is not aware of when an application session with an associated QoE measurement session is ongoing and the UE Access Stratum is also not automatically aware of this. To alleviate this session start/stop indications has been introduced, which are sent from the application layer in the UE to the UE AS and from the UE AS to the RAN. A session end indication is sent when the application session and the associated QoE measurement session are concluded.

The RAN may decide to release a QoE configuration in a UE at any time, as an implementation-based decision. Typically, it is done when the UE has moved outside an area configured for the QoE measurements (commonly referred to as the area scope) and the measurement session has ended.

### RAN Visible QoE (RVQoE)

An extension of the QoE framework which has been implemented in 3GPP release 17 is the concept of RAN Visible QoE (RVQoE). The regular QoE reports are intended for the MCE, which is an entity outside the RAN, e.g., a part of the OAM system, and the RAN cannot read the QoE reports (at least not according to specification, although gNB/eNB implementations are not prevented from doing so). In contrast, reported RVQoE metrics are intended for the RAN and are delivered to the RAN in a format that the RAN understands. The RVQoE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as change various parameters related to the scheduling of the UE and the data flows related to the application session.

### End-to-End Description of QoE Measurements

The end-to-end signaling for configuration of QoE measurements is described in 3GPP Technical Specification (TS) 28.405 v. 18.0.0, chapter 4. In chapter 4.5 of 3GPP TS 28.405, the activation of management based QoE in NR is described as shown in FIG. 1, which is a reproduction of FIG. 4.6.1.1-1 (QMC activation and reporting in NR after UE is registered) of 3GPP TS 28.405. In chapter 4.6 of 3GPP TS 28.405, the activation of signaling based QoE in NR is described as shown in FIG. 2.

### Configuration and Reporting of QoE and RVQoE Measurements in RRC

The configuration of QoE and RVQoE measurements is done by the RRC message RRCReconfiguration, and the reports are sent in the RRC message MeasurementReportAppLayer according to the signaling flow illustrated in FIG. 3.

The RRCReconfiguration contains the information element AppLayerMeasConfig, which contains either a configuration container for configuration of regular QoE or RRC parameters for configuration of RVQoE, as shown below:

### AppLayerMeasConfig

The IE AppLayerMeasConfig indicates configuration of application layer measurements.

### AppLayerMeasConfig Information Element

-- ASN1START
-- TAG-APPLAYERMEASCONFIG-START

| | |
|---|---|
| AppLayerMeasConfig-r17 ::= | SEQUENCE { |

```
  measConfigAppLayerToAddModList-r17 SEQUENCE (SIZE (1..maxNrofAppLayerMeas-
r17)) OF MeasConfigAppLayer-r17 OPTIONAL, -- Need N
  measConfigAppLayerToReleaseList-r17 SEQUENCE (SIZE (1..maxNrofAppLayerMeas-
r17)) OF MeasConfigAppLayerId-r17 OPTIONAL, -- Need N
```

| | |
|---|---|
| rrc-SegAllowed-r17 | ENUMERATED {enabled} |

OPTIONAL, -- Need R
...
}

| | |
|---|---|
| MeasConfigAppLayer-r17 ::= | SEQUENCE { |
| measConfigAppLayerId-r17 | MeasConfigAppLayerId-r17, |
| measConfigAppLayerContainer-r17 | OCTET STRING (SIZE (1..8000)) |

OPTIONAL, -- Need N

| | |
|---|---|
| serviceType-r17 | ENUMERATED {streaming, mtsi, vr, spare5, spare4, spare3, |

spare2, spare1} OPTIONAL, -- Need M

| | |
|---|---|
| pauseReporting-r17 | BOOLEAN |

OPTIONAL, -- Need M
transmissionOfSessionStartStop-r17 BOOLEAN
OPTIONAL, -- Need M

| | |
|---|---|
| ran-VisibleParameters-r17 | SetupRelease {RAN-VisibleParameters-r17} |

OPTIONAL, -- Cond serviceType
...
}

| | |
|---|---|
| RAN-VisibleParameters-r17 ::= | SEQUENCE { |
| ran-VisiblePeriodicity-r17 | ENUMERATED {ms120, ms240, ms480, ms640, ms1024} |

OPTIONAL, -- Need S

| | |
|---|---|
| numberOfBufferLevelEntries-r17 | INTEGER (1..8) |

```
OPTIONAL, -- Need R
  reportPlayoutDelayForMediaStartup-r17 BOOLEAN
OPTIONAL, -- Need M
  ...
}
-- TAG-APPLAYERMEASCONFIG-STOP
-- ASN1STOP
```

AppLayerMeasConfig field descriptions

measConfigAppLayerContainer
The field contains configuration of application layer measurements, see Annex L (normative)
in TS 26.247 [68], clause 16.5 in TS 26.114 [69] and TS 26.118 [70].
pauseReporting
The field indicates whether the transmission of measReportAppLayerContainer is paused or
not. Value true indicates the transmission of measReportAppLayerContainer is paused; value
false indicates the transmission of measReportAppLayerContainer is not paused.
ran-VisibleParameters
The field indicates whether RAN visible application layer measurements shall be reported or
not.
rrc-SegAllowed
This field indicates that RRC segmentation of MeasurementReportAppLayer is allowed. It may
be present only if the UE supports RRC segmentation of the MeasurementReportAppLayer
message in UL.
serviceType
Indicates the type of application layer measurement. Value streaming indicates Quality of
Experience Measurement Collection for streaming services (see TS 26.247 [68]), value mtsi
indicates Quality of Experience Measurement Collection for MTSI (see TS 26.114 [69]). value
vr indicates Quality of Experience Measurement Collection for VR service (see TS 26.118
[70]). The network always configures serviceType when application layer measurements are
initially configured and at fullConfig.
transmissionOfSessionStartStop
The field indicates whether the UE shall transmit indications when sessions in the application
layer start and stop. The UE transmits a session start indication upon configuration of this field
if a session already has started in the application layer.

RAN-VisibleParameters field descriptions

numberOfBufferLevelEntries
The field contains the maximum number of buffer level entries that can be reported for RAN
visible application layer measurements.
ran-VisiblePeriodicity
The field indicates the periodicity of RAN visible application layer measurements reporting.
Value ms120 indicates 120 ms, value ms 240 indicates 240 ms and so on.
reportPlayoutDelayForMediaStartup
The field indicates whether the UE shall report Playout Delay for Media Startup for RAN
visible application layer measurements.

| Conditional | |
|---|---|
| Presence | Explanation |
| serviceType | This field is optionally present, need M, |
| | when serviceType is set to |
| | streaming or vr. Otherwise, it is absent. |

MeasurementReportAppLayer contains either a report container for regular QoE or RRC parameters for report of RVQoE, as shown below:

### MeasurementReportAppLayer

The MeasurementReportAppLayer message is used for sending application layer measurement report.
Signalling radio bearer: SRB4
RLC-SAP: AM
Logical channel: DCCH
Direction: UE to Network

### MeasurementReportAppLayer Message

-- ASN1START
-- TAG-MEASUREMENTREPORTAPPLAYER-START

| | |
|---|---|
| MeasurementReportAppLayer-r17 ::= | SEQUENCE { |
| criticalExtensions | CHOICE { |

measurementReportAppLayer-r17 MeasurementReportAppLayer-r17-IEs,

| | |
|---|---|
| criticalExtensionsFuture | SEQUENCE { } |

```
  }
}
MeasurementReportAppLayer-r17-IEs ::= SEQUENCE {
  measurementReportAppLayerList-r17 MeasurementReportAppLayerList-r17,
```

| | |
|---|---|
| lateNonCriticalExtension | OCTET STRING |

OPTIONAL,

| | |
|---|---|
| nonCriticalExtension | SEQUENCE{ } |

OPTIONAL
}
MeasurementReportAppLayerList-r17 ::= SEQUENCE (SIZE (1..maxNrofAppLayerMeas-r17))
OF MeasReportAppLayer-r17

| | |
|---|---|
| MeasReportAppLayer-r17 ::= | SEQUENCE { |
| measConfigAppLayerId-r17 | MeasConfigAppLayerId-r17, |

measReportAppLayerContainer-r17 OCTET STRING
OPTIONAL,

| | |
|---|---|
| appLayerSessionStatus-r17 | ENUMERATED {started, stopped} |

OPTIONAL,

| | |
|---|---|
| ran-VisibleMeasurements-r17 | RAN-VisibleMeasurements-r17 |

OPTIONAL
}

| | |
|---|---|
| RAN-VisibleMeasurements-r17 ::= | SEQUENCE { |
| appLayerBufferLevelList-r17 | SEQUENCE (SIZE (1..8)) OF AppLayerBufferLevel-r17 |

OPTIONAL,

| | |
|---|---|
| playoutDelayForMediaStartup-r17 | INTEGER (0..30000) |

OPTIONAL,

| | |
|---|---|
| pdu-SessionIdList-r17 | SEQUENCE (SIZE (1..maxNrofPDU-Sessions-r17)) OF |
| PDU-SessionID | OPTIONAL, |

...
}
AppLayerBufferLevel-r17 ::= INTEGER (0..30000)
-- TAG-MEASUREMENTREPORTAPPLAYER-STOP
-- ASN1STOP

MeasReportAppLayer field descriptions

appLayerSessionStatus
Indicates that an application layer measurement session in the application layer starts or ends.
measReportAppLayerContainer
The field contains application layer measurement report, see Annex L (normative) in TS
26.247 [68], clause 16.5 in TS 26.114 [69] and TS 26.118 [70].
ran-VisibleMeasurements
The field contains the configuration of RAN visible application layer measurement parameters.

RAN-VisibleMeasurements field descriptions

appLayerBufferLevelList
The field indicates a list of application layer buffer levels, and each AppLayerBufferLevel
indicates the application layer buffer level in ms. Value 0 corresponds to 0 ms, value 1
corresponds to 10 ms, value 2 corresponds to 20 ms and so on. If the buffer level is larger than
the maximum value of 30000 (5 minutes), the UE reports 30000.
playoutDelayForMediaStartup
Indicates the application layer playout delay for media start-up in ms. Value 0 corresponds to
0 ms, value 1 corresponds to 1 ms, value 2 corresponds to 2 ms and so on. If the playout delay
for media start-up is larger than the maximum value of 30000 ms, the UE reports 30000.
pdu-SessionIdList
Contains the identity of the PDU session, or the identities of the PDU sessions, used for
application data flows subject to the RAN visible application layer measurements.

In existing specifications, the network can only configure RVQoE if there also is a corresponding configuration of regular QoE in the UE.

### QoE Metrics for Streaming Service

Specification concerning QoE metrics for Progressive Download and 3GPP Adaptive Hypertext Transfer Protocol (HTTP) Streaming, which is referred to as 3GP-DASH, can be found in 3GPP TS 26.247, clause 10.

The following metrics shall be supported by progressive download clients supporting the QoE reporting feature:
Average Throughput,
Initial Playout Delay
Buffer Level
Play List
Device information.

The following metrics shall be supported by 3GP-DASH clients supporting the QoE reporting feature:
List of Representation Switch Events,
Average Throughput,
Initial Playout Delay,
Buffer Level,
Play List,
MPD Information,
Device information.

### AT-Commands

AT commands are used for communication between the AS (radio) layer and the application layer in the UE. The AT commands are defined in 3GPP TS 27.007 version 17.6.0. The AT commands are used in QoE for transferring of the configuration from the RRC layer to the application and for transferring of reports from the application layer to the RRC layer.

### 3GPP Dual Connectivity

In 3GPP Rel-12, the LTE feature Dual Connectivity (DC) was introduced to enable the UE to be connected in two cell groups, each controlled by an LTE access node, eNBs, labelled as the Master eNB (MeNB) and the Secondary eNB (SeNB). The UE still only has one RRC connection with the network. In 3GPP, the Dual Connectivity (DC) solution has since then been evolved and is now also specified for NR as well as between LTE and NR. Multi-connectivity (MC) is the case when there are more than two nodes involved. With the introduction of 5G, the term MR-DC (Multi-Radio Dual Connectivity, see also 3GPP TS 37.340) was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Further, in MR-DC, when dual connectivity is configured for the UE, within each of the two cell groups, MCG and SCG, carrier aggregation may be used as well. In this case, within the Master Cell Group, MCG, controlled by the master node (MN), the UE may use one Primary Cell (PCell) and one or more Secondary Cells (SCells). And within the Secondary Cell Group, SCG, controlled by the secondary node (SN), the UE may use one Primary SCell (PSCell, also known as the primary SCG cell in NR) and one or more SCell(s). This combined case is illustrated in FIG. 4. In NR, the primary cell of a master or secondary cell group is sometimes also referred to as the Special Cell (SpCell). Hence, the SpCell in the MCG is the PCell and the SpCell in the SCG is the PSCell.

There are different ways to deploy 5G network with or without interworking with LTE (also referred to as E-UTRA) and evolved packet core (EPC). In principle, NR and LTE can be deployed without any interworking, denoted by NR stand-alone (SA) operation, also known as Option 2, that is gNB in NR can be connected to 5G core network (5GC) and eNB in LTE can be connected to EPC with no interconnection between the two, also known as Option 1.

On the other hand, the first supported version of NR uses dual connectivity, denoted as EN-DC (E-UTRAN-NR Dual Connectivity), also known as Option 3, as depicted in FIG. 5. In such a deployment, dual connectivity between NR and LTE is applied, where the UE is connected with both the LTE radio interface (LTE Uu in the figure) to an LTE access node and the NR radio interface (NR Uu in the figure) to an NR access node. Further, in EN-DC, the LTE access node acts as the master node (in this case known as the Master eNB, MeNB), controlling the master cell group, MCG, and the NR access node acts as the secondary node (in this case sometimes also known as the Secondary gNB, SgNB), controlling the secondary cell group, SCG. The SgNB may not have a control plane connection to the core network (EPC) which instead is provided MeNB and in this case the NR. This is also called as “Non-standalone NR” or, in short, “NSA NR”. Notice that in this case the functionality of an NR cell is limited and would be used for connected mode UEs as a booster and/or diversity leg, but an RRC_IDLE UE cannot camp on these NR cells.

With the introduction of 5GC, other options may be also valid. As mentioned above, option 2 supports stand-alone NR deployment where gNB is connected to 5GC. Similarly, LTE can also be connected to 5GC using option 5 (also known as eLTE, E-UTRA/5GC, or LTE/5GC and the node can be referred to as an ng-eNB). In these cases, both NR and LTE are seen as part of the NG-RAN (and both the ng-eNB and the gNB can be referred to as NG-RAN nodes).

It is worth noting that there are also other variants of dual connectivity between LTE and NR which have been standardized as part of NG-RAN connected to 5GC. Under the MR-DC umbrella, we have:
EN-DC (Option 3): LTE is the master node and NR is the secondary node (EPC CN employed, as depicted in FIG. 5)
NE-DC (Option 4): NR is the master node and LTE is the secondary (5GCN employed)
NGEN-DC (Option 7): LTE is the master node and NR is the secondary (5GCN employed)
NR-DC (variant of Option 2): Dual connectivity where both the master node, MN, controlling the MCG, and the secondary node, SN, controlling the SCG, are NR (5GCN employed, as depicted in FIG. 6).

### SUMMARY

Systems and methods related to Quality of Experience (QoE) and Radio Access Network (RAN) Visible QoE (RVQoE) measurement and reporting are disclosed. In one embodiment, a method performed by a User Equipment (UE) comprises receiving, from one or more network nodes, one or more messages comprising one or more QoE configurations and one or more RVQoE configurations. The method further comprises, for each QoE configuration or commonly for the one or more QoE configurations, receiving an indication that indicates a network node to which respective QoE reports are to be sent. The method further comprises, for each RVQoE configuration or commonly for the one or more RVQoE configurations, receiving an indication that indicates a network node to which respective RVQoE reports are to be sent. The method further comprises performing QoE measurements and RVQoE measurements in accordance with the one or more QoE configurations and the one or more RVQoE configuration. The method further comprises, for each QoE report from among one or more QoE reports comprising results of the QoE measurements, transmitting the QoE report to the indicated network node to which the QoE report is to be sent. The method further comprises, for each RVQoE report from among one or more RVQoE reports comprising results of the QoE measurements, transmitting the RVQoE report to the indicated network node to which the QoE report is to be sent. In this manner, QoE reports and RVQoE reports may be routed to different entities.

In one embodiment, the network node to which QoE reports are to be sent for at least one of the one or more QoE configurations is different than the network node to which the RVQoE reports are to be sent for at least one of the one or more RVQoE configurations.

In one embodiment, the method comprises, for each QoE configuration, receiving an indication that indicates a network node to which respective QoE reports are to be sent. In one embodiment, for each QoE configuration from among the one or more QoE configurations, the indication that indicates the network node to which respective QoE reports are to be sent is either comprised in the QoE configuration or in a message(s) that can contain the QoE configuration. In one embodiment, for at least one QoE configuration from among the one or more QoE configurations, the indication that indicates the network node to which respective QoE reports are to be sent is an indication of a Signaling Radio Bearer (SRB) on which to transmit the respective QoE report.

In one embodiment, the method comprises, for each RVQoE configuration, receiving an indication that indicates a network node to which respective RVQoE reports are to be sent. In one embodiment, for each RVQoE configuration from among the one or more RVQoE configurations, the indication that indicates the network node to which respective RVQoE reports are to be sent is either comprised in the RVQoE configuration or in a message(s) that contains the RVQoE configuration. In one embodiment, for at least one RVQoE configuration from among the one or more RVQoE configurations, the indication that indicates the network node to which respective RVQoE reports are to be sent is an indication of a SRB on which to transmit the respective RVQoE report.

In one embodiment, the method comprises, commonly for all of the one or more QoE configurations, receiving an indication that indicates a common network node to which QoE reports are to be sent. In one embodiment, the indication that indicates the common network node to which the QoE reports are to be sent is either comprised in at least one of the one or more QoE configurations or in a message(s) that contains at least one of the one or more QoE configurations.

In one embodiment, the method comprises, commonly for all of the one or more RVQoE configurations, receiving an indication that indicates a common network node to which respective RVQoE reports are to be sent. In one embodiment, the indication that indicates the common network node to which the RVQoE reports are to be sent is either comprised in at least one of the one or more RVQoE configurations or in a message(s) that contains at least one of the one or more RVQoE configurations. In one embodiment, the indication that indicates the common network node to which the RVQoE reports are to be sent is an indication of an SRB on which to transmit the RVQoE reports.

Corresponding embodiments of a UE are also disclosed. In one embodiment, a UE is adapted to receive, from one or more network nodes, one or more messages comprising one or more QoE configurations and one or more RVQoE configurations. The UE is further adapted to, for each QoE configuration or commonly for the one or more QoE configurations, receive an indication that indicates a network node to which respective QoE reports are to be sent. The UE is further adapted to, for each RVQoE configuration or commonly for the one or more RVQoE configurations, receive an indication that indicates a network node to which respective RVQoE reports are to be sent. The UE is further adapted to perform QoE measurements and RVQoE measurements in accordance with the one or more QoE configurations and the one or more RVQoE configurations. The UE is further adapted to, for each QoE report from among one or more QoE reports comprising results of the QoE measurements, transmit the QoE report to the indicated network node to which the QoE report is to be sent. The UE is further adapted to, for each RVQoE report from among one or more RVQoE reports comprising results of the QoE measurements, transmit the RVQoE report to the indicated network node to which the QoE report is to be sent.

In one embodiment, a UE comprises a communication interface and processing circuitry associated with the communication interface. The processing circuitry is configured to cause the UE to receive, from one or more network nodes, one or more messages comprising one or more QoE configurations and one or more RVQoE configurations. The processing circuitry is further configured to cause the UE to, for each QoE configuration or commonly for the one or more QoE configurations, receive an indication that indicates a network node to which respective QoE reports are to be sent. The processing circuitry is further configured to cause the UE to, for each RVQoE configuration or commonly for the one or more RVQoE configurations, receive an indication that indicates a network node to which respective RVQoE reports are to be sent. The processing circuitry is further configured to cause the UE to perform QoE measurements and RVQoE measurements in accordance with the one or more QoE configurations and the one or more RVQoE configurations. The processing circuitry is further configured to cause the UE to, for each QoE report from among one or more QoE reports comprising results of the QoE measurements, transmit the QoE report to the indicated network node to which the QoE report is to be sent. The processing circuitry is further configured to cause the UE to, for each RVQoE report from among one or more RVQoE reports comprising results of the QoE measurements, transmit the RVQoE report to the indicated network node to which the QoE report is to be sent.

Embodiments of a method performed by a first network node are also disclosed. In one embodiment, a method performed by a first network node comprises transmitting, to a UE, one or more messages comprising one or more QoE configurations and one or more RVQoE configurations. The one or more messages further comprise, for each QoE configuration or commonly for the one or more QoE configurations, an indication that indicates a network node to which respective QoE reports are to be sent and, for each RVQoE configuration or commonly for the one or more RVQoE configurations, an indication that indicates a network node to which respective RVQoE reports are to be sent.

Corresponding embodiments of a first network node are also disclosed.

Embodiments of a method performed by a second network node are also disclosed. In one embodiment a method performed by a second network node comprises receiving, from a UE, one or more messages comprising one or more QoE reports associated to one or more QoE configurations and one or more RVQoE reports associated to one or more RVQoE configurations. For each QoE configuration or commonly for the one or more QoE configurations, the UE is either configured with or determines a network node to which respective QoE reports are to be sent. For each RVQoE configuration or commonly for the one or more RVQoE configurations, the UE is either configured with or determines a network node to which respective RVQoE reports are to be sent.

Corresponding embodiments of a second network node are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a reproduction of FIG. 4.6.1.1-1 (Quality of Experience (QoE) Measurement Collector (QMC) activation and reporting in New Radio (NR) after User Equipment (UE) is registered) of 3^{rd} Generation Partnership Project (3GPP) Technical Specification (TS) 28.405 V18.0.0;

FIG. 2 illustrates activation of signaling based QoE in NR;

FIG. 3 illustrates the signaling flow for configuration of QoE and Radio Access Network (RAN)-Visible QoE (RVQoE) measurement and reporting as well as QoE and RVQoE reporting;

FIG. 4 illustrates an example of a combined case of Dual Connectivity (DC) and Carrier Aggregation (CA);

FIG. 5 illustrates an example of DC;

FIG. 6 illustrates another variant of DC;

FIG. 7 is a flow chart that illustrates the operation of a wireless terminal (also called a User Equipment—UE), for QoE/RVQoE measurement configuration and reporting in accordance with an embodiment of the present disclosure;

FIG. 8 illustrates the operation of a network node configured as a Master Node (MN) for a UE, for QoE measurement configuration and reporting, in accordance with one embodiment of the present disclosure;

FIG. 9 illustrates the operation of a network node configured as a Secondary Node (SN) for a UE, for QoE measurement configuration and reporting, in accordance with an embodiment of the present disclosure;

FIG. 10 shows an example of a communication system in accordance with some embodiments;

FIG. 11 shows a UE in accordance with some embodiments;

FIG. 12 shows a network node in accordance with some embodiments;

FIG. 13 is a block diagram of a host, which may be an embodiment of the host of FIG. 10, in accordance with various aspects described herein;

FIG. 14 is a block diagram illustrating a virtualization environment in which functions implemented by some embodiments may be virtualized; and

FIG. 15 shows a communication diagram of a host communicating via a network node with a UE over a partially wireless connection in accordance with some embodiments.

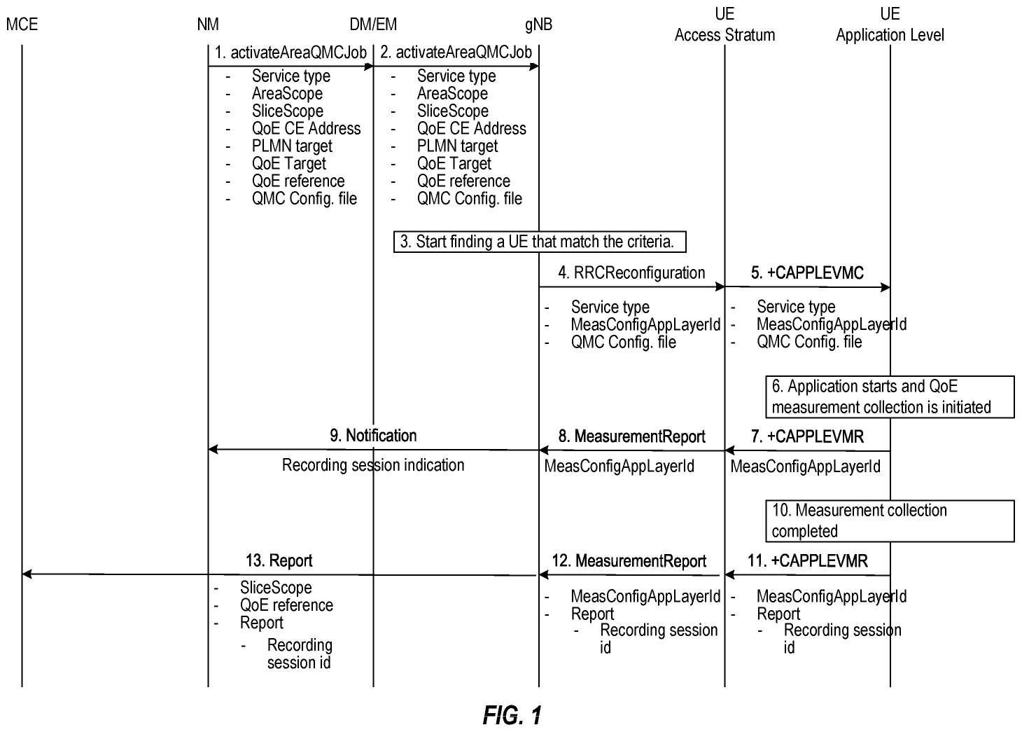

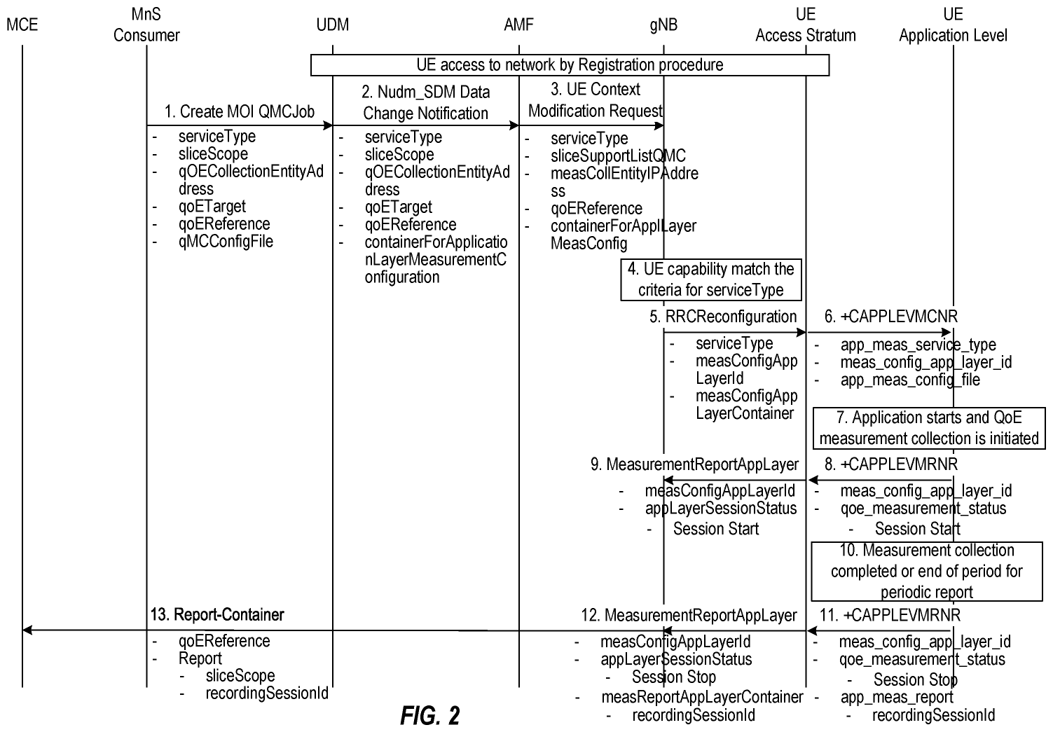

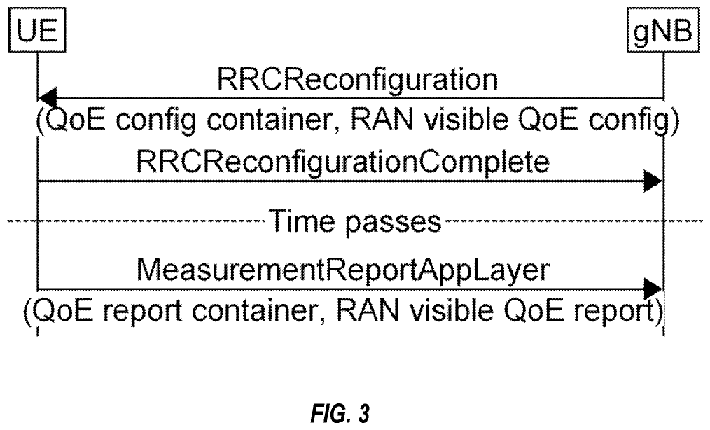

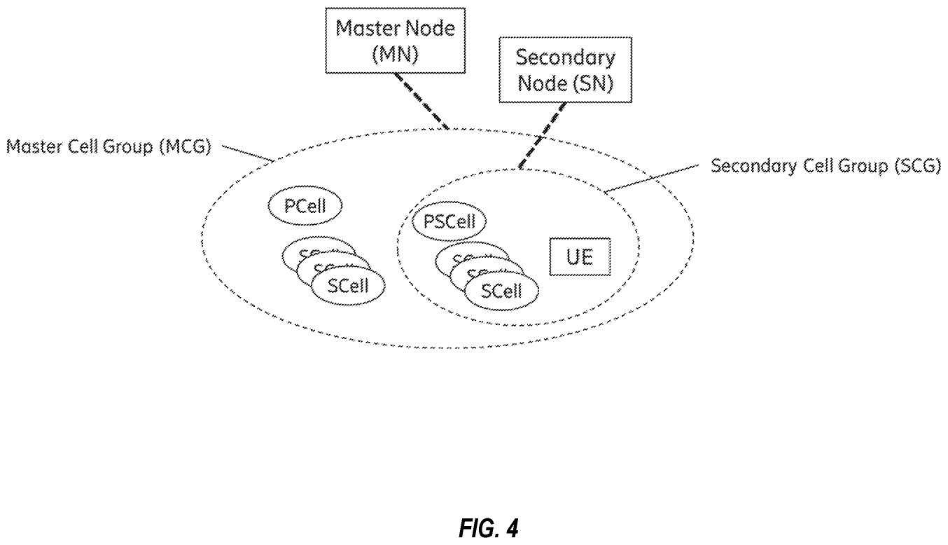

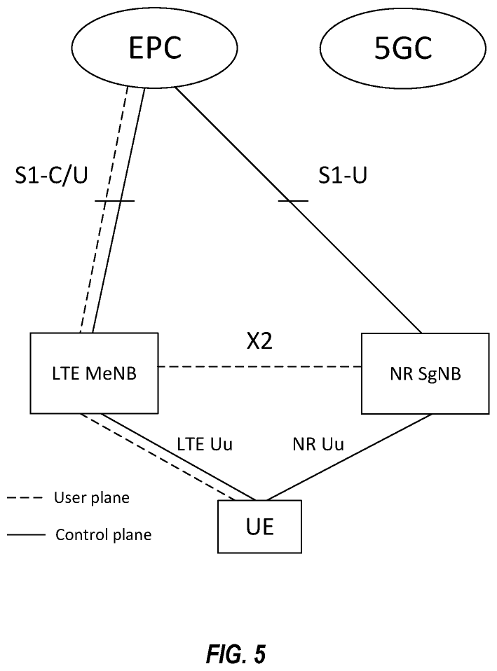

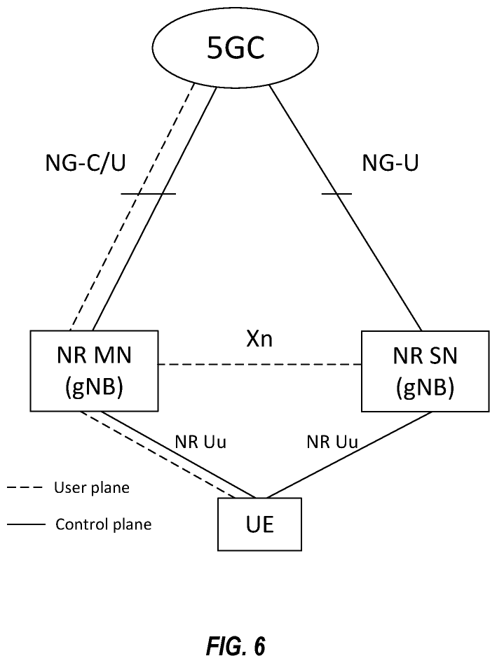

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). Quality of Experience (QoE) reports and Radio Access Network (RAN)-Visible QoE (RVQoE) reports serve quite different purposes, i.e., the former being mainly application-level feedback for offline analysis and long-term adaptations and the latter being real-time feedback from the application to the RAN for immediate adaptations of the treatment of an ongoing application session. In current 3GPP specifications, QoE and RVQoE measurement reports are always reported in the same way according to the same configuration, e.g. to the same node in case of New Radio (NR) Dual Connectivity (NR-DC). This is an unnecessary limitation, especially since the reports serve different purposes and have different recipients.

Certain aspects of the disclosure and their embodiments may provide solutions to these or other challenges. Embodiments of systems and methods are disclosed herein that provide solutions for directing QoE reports and RVQoE reports respectively to specific network nodes, e.g., in a dual connectivity scenario (e.g., in an NR-DC scenario). This may be achieved by configuring the UE with an indication indicating a node or cell group to which to transmit the QoE reports and an indication indicating a node to which to transmit the RVQoE reports. The indication may comprise, e.g., any one or more of the following indications:
an explicit indication of the node or cell group (e.g., Master Cell Group (MCG), Secondary Cell Group (SCG)),
an indication to send the report to the cell group that carries the data flow(s) of the application session the report pertains to,
an indication of the Signaling Radio Bearer (SRB) to use for the transmission,
an indication (explicit or implicit) that the report should be sent to the node that sent the configuration,
an indication (explicit or implicit) that the report should be sent to the node which handles the Data Radio Bearer(s) (DRB(s)) which carries/carry the data flow(s) of the application session the report pertains to,
an indication (explicit or implicit) that the User Equipment (UE) may autonomously decide which node(s) to send the report to.

When the UE has a QoE or a RVQoE report to send, the UE transmits the report according to the indications included in the configuration. In one embodiment, if the report is targeted for the Master Node (MN) in the case of dual connectivity, the UE may use the MeasurementReportAppLayer message to transmit the report to the MN. In one embodiment, if the report is intended for the Secondary Node (SN), the UE may use the ULInformationTransferMRDC message, with an encapsulated MeasurementReportAppLayer message for the SN. In one embodiment, the encapsulated MeasurementReportAppLayer message may be forwarded from the MN to the SN in an XnAP RRC TRANSFER message. Alternatively, the UE may be configured with SRB3 or SRB5 for direct transmission to the SN. In both of the options, there is a clear separation of which messages that are intended for the MN and which messages that are intended for the SN. With the option to configure different nodes for the QoE and RVQoE reports, the network can direct the reports to the node which is the preferred receiver of the reports.

Certain embodiments may provide one or more of the following technical advantage(s). Embodiments of the present disclosure may enable more flexibility regarding the transmission of QoE and RVQoE reports. In the solution, RVQoE reports may be routed to the RAN node which is the intended recipient of the report, whereas QoE reports which are aimed for Operations, Administration, and Maintenance (OAM) may be routed to a different RAN node. This is advantageous as the QoE reports may be large and it is beneficial if the network can configure the UE to send these reports to the less loaded node without having to configure also the shorter RVQoE reports to the less loaded node as these reports are intended for a particular node.

### 1 Notes and Terminology

In several embodiments described below, the Radio Access Network (RAN) sends a request to a User Equipment (UE) for RAN Visible Quality of Experience (RVQoE) report(s). Such a request may equivalently be referred to as an indication to a UE to send RVQoE report(s) or an indication of fulfillment or a RAN event (or RAN event(s)) to trigger RVQoE reporting.

Many field (i.e., parameter) names or Information Element (IE) names in the Radio Resource Control (RRC) configuration for New Radio (NR) (3GPP TS 38.331 version 17.1.0) are referred to either as a name with a postfix indicating the 3GPP standard release (e.g. “-r17” indicating 3GPP release 17) or as the same name without the postfix. The version with the postfix is then used in the ASN.1 code, while the version without the postfix is used in other text in the specification. In this document, when applicable (i.e., when both versions of a field's name exist in 3GPP TS 38.331 version 17.1.0), the two versions of the name are used interchangeably. For instance, the names “AppLayerMeasConfig” and “AppLayerMeasConfig-r17” refers to the same IE.

A RAN node can be a next generation Node B (gNB), evolved Node B (eNB), en-gNB, next generation eNB (ng-eNB), gNB Central Unit (gNB-CU), gNB-CU Control Plane part (gNB-CU-CP), gNB-CU User Plane part (gNB-CU-UP), eNB Central Unit (eNB-CU), eNB-CU Control Plane part (eNB-CU-CP), eNB-CU User Plane part (eNB-CU-UP), Integrated Access and Backhaul (IAB) node, IAB-donor Distributed Unit (DU), IAB-donor Central Unit (CU), IAB-DU, IAB Mobile Termination (IAB-MT), Open RAN CU (O-CU), O-CU Control Plane part (O-CU-CP), O-CU User Plane part (O-CU-UP), Open RAN Distributed Unit (O-DU), Open RAN Radio Unit (O-RU), Open RAN eNB (O-eNB), a Non-Real Time RAN Intelligent Controller (Non-RT RIC), a Real-Time RAN Intelligent Controller (RT-RIC), or the like.

The terms “application layer measurement configuration”, “application measurement configuration”, “QoE measurement configuration”, “QoE configuration”, “QoE measurement and reporting configuration” and “QMC configuration” are used interchangeably. But note that the “QMC configuration file” is not an equivalent term, but instead refers to the part of the QoE configuration consisting of an XML file containing instructions of QoE metrics to be collected etc.

The solution(s) proposed herein applies to both signaling- and management-based Quality of Experience (QoE) measurements (but may also optionally be restricted to apply to only one of them).

The terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.

The terms “QoE configuration” and “QoE measurement configuration” are used interchangeably. Similarly, the terms “RVQoE configuration” and “RVQoE measurement configuration” are used interchangeably.

The terms “access stratum” and “radio layer” are used interchangeably when referring to a UE.

The solution(s) is equally applicable to QoE and RAN visible QoE measurements and reporting, meaning, among other things that the considerations of QoE configurations, QoE measurements and QoE reports apply also to RVQoE configurations, RVQoE measurements and RVQoE reports.

The solution(s) is presented on the example of a UE in dual connectivity, but it also may apply to radio access technologies where the UE is served by more than two legs.

The solution(s) proposed herein applies to NR as well as future Radio Access Technologies (RATs) such as 6G, with the IAB-MT a parent backhaul link terminating function and the IAB-DU an access service providing function of a relay node.

“Sending reports to a node” may or may not mean that the said node is the consumer, i.e., the end destination of the reports.

The terms “node” and “network node” are used interchangeably herein.

Transmission to a Master Node (MN) or transmission to a Secondary Node (SN), means using the carriers in the Master Cell Group (MCG) and the carriers in the Secondary Cell Group (SCG) respectively.

### 2 Overview

As mentioned above, QoE reports and RVQoE reports serve quite different purposes. This is reflected by the fact that the RAN forwards QoE reports (uninterpreted) to the Measurement Collection Entity (MCE), whereas RVQoE reports are kept in the RAN, analyzed, and used as a basis for possible adaptations of the treatment of ongoing application session data flows. This is an existing example of differential treatment of QoE reports and RVQoE reports. However, other aspects of differential treatment of QoE reports and RVQoE reports may be beneficial, especially as the QoE/RVQoE framework is extended with new service types, scenarios, and features. One such particular example is targeted by embodiments of the proposed solution(s).

When the QoE/RVQoE framework in 3GPP release 18 is extended to be applicable to NR Dual Connectivity (NR-DC) scenarios, the different purposes of QoE measurements/reports and RVQoE measurements/reports imply that different network nodes (i.e., the MN and the SN) may be the preferable receiver of QoE reports and RVQoE reports. In particular, it is preferable that the RVQoE reports are sent to the node that can impact the treatment of the data flow of the application session the RVQoE reports pertain to, i.e. the node that handles the data flow of the application session the RVQoE reports pertain to.

As an example, consider a UE in NR-DC mode with different gNBs acting as respectively the MN and the SN. Furthermore, the MN has received a signaling-based QoE configuration from the core network (CN) (i.e., the Access and Mobility Management Function (AMF)) and forwarded it to the concerned UE, and the RAN (the MN, the SN, or both in concert) has also configured the UE with corresponding RVQoE measurements. If the data flow of an application session of the service type targeted by the QoE configuration and RVQoE configuration is then sent via the SN (i.e., on an SCG bearer), then the network may want the QoE reports to go to the MN and the RVQoE reports to go to the SN.

This may be achieved in a number of ways:

One way is to leverage the legacy mechanism of forwarding Radio Resource Control (RRC) messages from the UE via the MN to the SN embedded in transfer messages. Over the Uu interface between the UE and the MN, such a transfer message is the ULInformationTransferMRDC RRC message. Over the Xn interface, such a transfer message is the RRC TRANSFER XnAP message. Leveraging this legacy mechanism, a UE could e.g. send a MeasurementReportAppLayer RRC message containing a QoE report to the MN as a regular RRC message, while a MeasurementReportAppLayer RRC message containing an RVQoE report could be encapsulated in an ULInformationTransferMRDC RRC message which is sent to the MN, after which the MN extracts the MeasurementReportAppLayer RRC message containing the RVQoE report from the ULInformationTransferMRDC RRC message and forwards the extracted MeasurementReportAppLayer RRC message to the SN in an RRC TRANSFER XnAP message. (SRB3, see next paragraph, has been introduced in the standard to allow direct transfer of RRC messages from the UE to the SN, so the above encapsulation and forwarding mechanism is primarily intended to be used when SRB3 is not configured or implemented.)

Another way is to utilize Signaling Radio Bearers (SRBs) inherently intended for different nodes. As one example, the UE can send QoE reports on SRB4 to the MN and send RVQoE reports on SRB3 to the SN. Instead of SRB3, a new signaling radio bearer denoted as SRB5 may be used for transmission of QoE/RVQoE reports to the SN. It is currently discussed in 3GPP to introduce such a new signaling radio bearer (SRB5) for the purpose of transmitting QoE reports and RVQoE reports to the SN. With the current example, the UE could send QoE reports on SRB4 to the MN and send RVQoE reports on SRB5 to the SN.

Note that the choice to send QoE reports to the MN and RVQoE reports to the SN, as described above, was just an example, and the opposite, i.e. sending QoE reports to the SN and RVQoE reports to the MN, is also in line with the proposed solution, as well as sending both QoE reports and RVQoE reports to the same node, i.e. either to the MN or to the SN.

This kind of differential treatment of QoE reports and RVQoE reports requires new signaling possibilities to instruct the UE, e.g. to send QoE reports to the MN on SRB4 and RVQoE reports to the SN on SRB3 or SRB5, or to send QoE reports to the MN but encapsulate RVQoE reports in ULInformationTransferMRDC RRC messages (i.e. to send a RVQoE report, include the relevant RVQoE report parameters in a MeasurementReportAppLayer RRC message and encapsulate the MeasurementReportAppLayer RRC message in an ULInformationTransferMRDC RRC message and send the ULInformationTransferMRDC RRC message to the MN). In such control signaling, an instruction to send a certain type of reports to a certain node may have the form of, e.g., any one or more of the following:
an indication of the node (e.g., MN, SN),
an indication to send the report to the node that carries the data flow(s) of the application session the report pertains to,
an indication of the cell group (e.g., MCG, SCG),
an indication to send the report to the cell group that carries the data flow(s) of the application session the report pertains to,
an indication of the SRB to transmit on (e.g., SRB4 implies MN and SRB5 implies SN),
an indication that a MeasurementReportAppLayer message containing a certain report type should be included in a message (e.g., an ULInformationTransferMRDC RRC message) which is used for encapsulating a message to be forwarded from the MN to the SN (or vice versa),
absence of an indication can be an implicit indication that the report should be sent to the node that sent the configuration,
absence of an indication can be an implicit indication that the report should be sent to the node which handles the DRB(s) which carries/carry the data flow(s) of the application session the report pertains to,
absence of an indication can be an implicit indication that the UE can autonomously decide which node to send the report to.

Through such instructions, the UE's QoE/RVQoE report transmission behavior could be controlled per QoE/RVQoE configuration or generally for all QoE/RVQoE configurations in the UE, depending on at what IE level in the ASN.1 definitions (e.g. based on the ASN.1 definitions in 3GPP TS 38.331 version 17.2.0) the control parameters are placed, e.g. in the AppLayerMeasConfig-r17 IE or the MeasConfigAppLayer-r17 IE and/or the RAN-VisibleParameters-r17 IE. Examples are provided below in section 3.2.

In section 3, embodiments of the proposed solution are further described in terms of methods/embodiments for respectively the UE, the MN, and the SN.

### 3 Embodiments

3.1 Configuration and Reporting of QoE and RVQoE Measurements, with the Option to Transmit the QoE and RVQoE Reports to Different Nodes

Note that in all the methods described in this section, the roles of the MN and the SN may be swapped. That is the actions performed by the MN in the method descriptions may be performed by the SN and vice versa. Similarly, the interactions the UE has with the MN and the SN respectively may be swapped between the MN and the SN. The methods, as described, will in general apply even after such swapping. In addition, the configuration related to QoE reports and related to RVQoE reports may be swapped, so that any configuration is possible for both QoE and for RVQoE respectively. In RRC TS 38.331, the terms MN and SN are not commonly used, but the UE is configured with an MCG (Master Cell Group) related to the MN and an SCG (Secondary Cell Group) related to the SN.

### 3.1.1 Embodiments for the UE

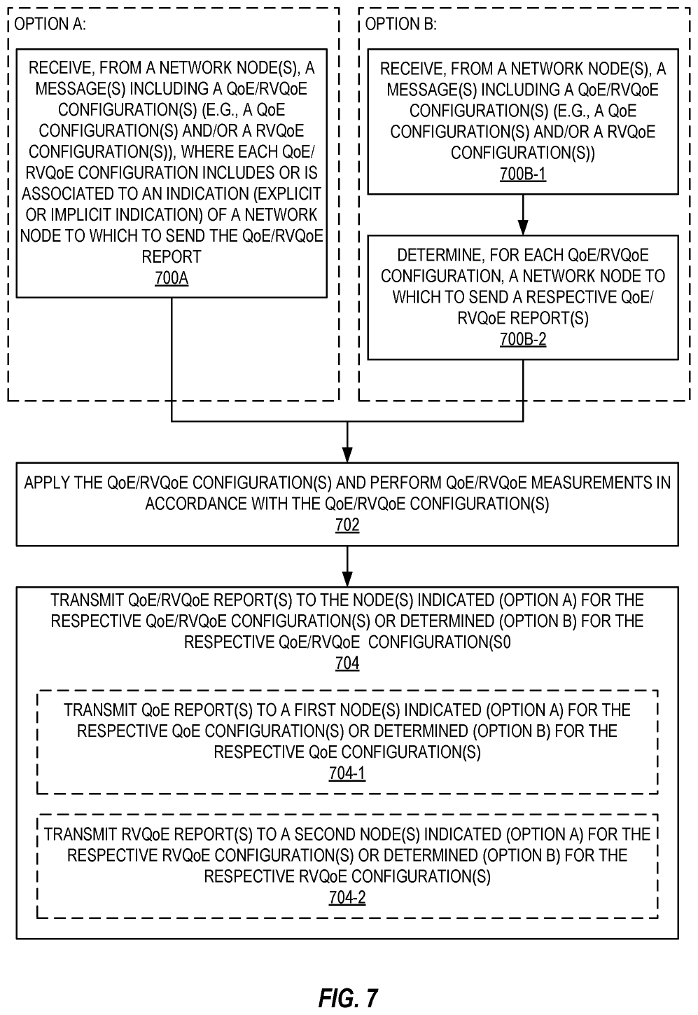

FIG. 7 is a flow chart that illustrates the operation of a wireless terminal (also called a User Equipment—UE), for QoE/RVQoE measurement configuration and reporting in accordance with an embodiment of the present disclosure. As illustrated, the procedure of FIG. 7 includes the following:
Step 700A: In a first alternative or option (Option A), the wireless terminal receives, from one or more network nodes, such as an MN or an SN, one or multiple messages, e.g., RRCReconfiguration message(s). The message(s) may comprise one or more QoE configurations (e.g., configuration of QoE measurements and configuration of RVQoE measurements) and each QoE/RVQoE configuration, or at least one of the QoE/RVQoE configuration(s), may comprise, or is sent together with (e.g. in the same message), an indication of the network node to which the UE shall send the QoE reports and/or the RVQoE reports, respectively. In one embodiment, the indication indicates that the UE may decide which network node to send the QoE reports and/or RVQoE reports to (wherein this decision may or may not be based on a specified or configured procedure or a specified or configured rule or specified or configured criteria and/or based on input data provided by the network node).
   The indication of the node may be an explicit or an implicit indication.
   An example of an explicit indication is an indication, indicating, e.g., the network node such as the MN or the SN, or the MCG or the SCG.
   In another option, the indication indicates the SRB that the UE should use to send the reports.
   In one version of this embodiment, if the UE can send the reports to either the MN or the SN, then, if the explicit indication is absent, the UE interprets this as that the UE can send the report to either of the MN or the SN.
   As another option, absence of the explicit indication may be an implicit indication that the UE should send the reports (i.e. the QoE reports or the RVQoE reports depending on whether the absent indication is associated with the QoE configuration or the RVQoE configuration) to the node from which it received the associated configuration (i.e. the QoE configuration or RVQoE configuration).
   As yet another option, the indication of which node to send QoE reports and/or RVQoE report to may apply to all QoE configurations and/or to all RVQoE configurations in the UE. With this option, the indication may be sent once to the UE, e.g. in an RRCReconfiguration message, instead of associating a separate indication with each QoE and/or RVQoE configuration.
   An implicit indication may e.g. be the configuration of a certain SRB linked to the configuration of the QoE or RVQoE measurements, where the SRB is to be used for sending of QoE reports and/or RVQoE reports.
   An implicit indication could also depend on in which part of the RRC message the configuration is included. For instance, if the configuration is included in the MN part of the message, the UE shall send the reports to the MN, while if the configuration is included in the SN part of the message, the UE shall send the reports to the SN.
   Another implicit indication may be that the UE should send the QoE reports to the node from which it received the QoE configuration, and the RVQoE reports to the node from which it received the RVQoE configuration.
   Alternatively, an implicit indication, may e.g., be the configuration of certain identifiers (e.g., measConfigAppLayerId) associated to QoE/RVQoE configurations, where a first set of identifiers is reserved for MN and another set of identifiers is reserved for SN. For instance, the first set of identifiers can be represented by all the possible values of the measConfigAppLayerId-r17 IE, and is reserved for QoE/RVQoE configuration which the MN can configure for the UE, and the second set of identifiers can be represented by all the possible values of another IE—e.g., measConfigAppLayerId-r18, and is reserved for SN.
   An explicit indication can be realized by indicating the DRBs the UE should use when sending/receiving the application data towards/from a certain network node that contributed in preparing a RVQoE configuration or that sends a QoE/RVQoE configuration to the UE. For instance, a first list of DRBs is included in the QoE configuration (or RVQoE configuration) of the UE, to indicate that when UE sends/receives data of an application towards/from the MN node, the UE should use DRB ID=X1, Y1, Z1. This can be included in the QoE configuration as part of an “MCG-related” configuration. A second list of DRBs can also be included in the same QoE/RVQoE configuration (or In a separate QoE/RVQoE configuration) to indicate that in case the UE sends/receives application data towards/from the SN node, it can use another set of DRBs (e.g. as included in a “SCG-related” configuration), e.g., DRB ID=X2, Y2, Z2. The MN and SN, to determine the list of MN-related DRBs and SN-related DRBs associated to QoE/RVQoE reporting of the UE respectively towards MN and SN, can execute a coordination procedure, where one of the nodes, responsible for determining which DRBs the UE will use towards which node (e.g., the MN node) indicates a list of DRBs that UE should use when sending/receiving data for an application towards/from the MN node, and it optionally suggests a second list of DRBs that UE should use when sending/receiving data for an application towards/from the SN node. The other node, e.g. the SN node, can reply with a list of DRBs that the UE should use when sending/receiving data for an application towards/from itself, and may accept or reject suggestion from the responsible node (in the example, the MN).
   The list of MN-related DRBs can be included in an RVQoE configuration prepared by the MN for RVQoE reports the MN wants to receive (e.g., as part of an MN-RVQoE configuration, or an MCG-RVQoE configuration). The MN can also send to the UE at least a portion of an RVQoE configuration as prepared by the SN and containing the list of SN-related DRBs (e.g., as part of an SN-RVQoE configuration, or an SCG-RVQoE configuration).
   The list of DRBs associated to MN and the list of DRBs associated to SN may not be explicitly indicated for the purpose of QoE/RVQoE, but the UE may receive it regardless of QoE handling and (re)use the same lists when sending application data subject to QoE/RVQoE measurements.
   Alternatively, the UE may be provided with information to derive the node to which the reports should be sent. The indication may, e.g., be an indication to the UE to send the QoE reports and/or the RVQoE reports respectively, to the node which carries the data of the application session the QoE measurements and/or RVQoE measurements are performed on.
   The UE may also be instructed by the network where to send the QoE reports and/or RVQoE reports in case of different reconfigurations pertaining to dual connectivity.
      In case the UE is instructed to send the QoE reports and/or RVQoE reports to the node that carries the data for the application session (as mentioned above, the UE may be provided with information to derive the node to which the reports should be sent), the explicit indication can instruct the UE where to send the reports in case the node carrying the application session changes (which can happen for various reasons). Some non-limiting examples can be:
         For the case that the MN and SN serving the UE remain the same, but the node that carries the session changes (e.g., the change is that data flow for the session starts being carried via MN, and, so far, it was carried via the SN), the UE may be instructed to:
         Send, from now on, the QoE reports and/or RVQoE reports to the node that from now on carries the session, instead of towards the node to which the QoE and/or RVQoE reports were sent so far.
         Send, from now on, the QoE reports and/or RVQoE reports to the node that from now on carries the session, instead of towards the node to which the reports were sent so far.
         Continue to report to the node that currently receives the QoE reports and/or RVQoE.
         For the case of mobility, e.g., MN change, SN change, the explicit indication can instruct the UE where to send the QoE reports and/or RVQoE reports:
         Continue to send the QoE reports and/or RVQoE reports to the node that plays the same role in dual connectivity as the node towards which the QoE reports were sent so far (MN role or SN role).
         If the QoE reports and/or RVQoE reports were so far sent to the MN, continue to send the reports to the MN (in case of MN change send from now on to the new MN).
         If the QoE reports and/or RVQoE reports were so far sent to the SN, continue to send the reports to the SN (in case of SN change send from now on to the new SN).
         Send, from now on, the reports towards a specific node, MN or SN.
         For the case of changing from single to dual connectivity (SN addition) the explicit indication can instruct the UE where to send the reports, e.g.:
         Send, from now on, the reports to the SN.
         Continue to report to the node that so far received the reports, e.g., the MN.
   The indication of the network node to which UE shall send the QoE reports and the RVQoE reports, respectively, may be the same node for QoE reports and RVQoE reports or it may be different node for QoE reports and RVQoE reports.
   The configuration of QoE measurements and the configuration of RVQoE measurements may be done in the same message or in different messages. The configuration of the indication to which node the UE shall transmit the reports may be sent together with the configuration of the QoE/RVQoE measurements, or be sent separate from the configuration of the measurements.
   The message with the configuration to the UE may be sent from the MN, from the SN or from both the MN and the SN.
Steps 700B-1 and 700B-2: In a second alternative or option (Option B), the wireless terminal receives one or multiple messages from a network node, e.g. RRCReconfiguration, message(s), the message(s) comprising one or more QoE configurations (e.g. and/or one or more RVQoE configurations) and for each QoE/RVQoE configuration, or for at least one of the QoE/RVQoE configuration(s), the UE determines which network node to which the UE shall send the QoE and/or the RVQoE reports. This alternative allows the UE to decide which node the UE sends the reports to.
Step 702: The wireless terminal applies the QoE/RVQoE configuration(s) received and performs QoE/RVQoE measurements according to the configuration(s).
Step 704: The wireless terminal transmits QoE/RVQoE reports to the network node indicated (explicitly, implicitly, or derivable) in the respective QoE/RVQoE configuration(s) (or together with the QoE configuration(s)), as recipient of the QoE/RVQoE reports.
   Step 704-1: The wireless terminal transmits QoE report(s) to a first network node(s) indicated (as in step 700A) or determined by the wireless terminal (as in step 700B-2 of Option B), for the respective QoE configuration(s).
      If the configuration indicated that QoE reports should be sent to the MN, including the QoE report in a message to the MN. The message containing the QoE report may be a MeasurementReportAppLayer message sent, e.g., on SRB4.
      If the configuration indicated that QoE report should be sent to the SN, including the QoE report in a message to the SN. The message containing the QoE report may be a MeasurementReportAppLayer message sent, e.g., on SRB3 or a new SRB5 configured towards the SN. Alternatively, the message may be an ULInformationTransferMRDC message with an embedded MeasurementReportAppLayer message, sent on SRB4 to the MN for onward transfer to the SN. The message can also be a newly defined message.
   Step 704-2: The wireless terminal transmits RVQoE reports to a second network node(s) indicated (explicitly, implicitly, or derivable) in the RVQoE configuration (or together with the RVQoE configuration), as recipient of the RVQoE reports. In other words, the wireless terminal transmits RVQoE reports to second network node(s) indicated (as in step 700A) or determined by the wireless terminal (as in step 700B-2 of Option B), for the respective RVQoE configuration(s). Note that since they are separately indicated or determined, the first network node(s) to which the QoE report(s) is(are) sent may be different than the second network node(s) to which the RVQoE report(s) is(are) sent.
      If the configuration indicated that RVQoE reports should be sent to the MN, including the RVQoE report in a message to the MN. The message containing the RVQoE report may be a MeasurementReportAppLayer message sent, e.g., on SRB4 or SRB1.
      If the configuration indicated that RVQoE report should be sent to the SN, including the RVQoE report in a message to the SN. The message containing the RVQoE report may be a MeasurementReportAppLayer message sent, e.g., on SRB3 or a new SRB5 configured towards the SN. Alternatively, the message may be an ULInformationTransferMRDC message with an embedded MeasurementReportAppLayer message, sent on SRB4 or SRB1 to the MN for onward transfer to the SN. The message can also be a newly defined message.

The configuration of the node to which the reports are sent may or may not be the same for all QoE measurement configurations or all RVQoE measurement configurations in the UE. The UE may, e.g., be configured to transmit some QoE or RVQoE reports to the MN and some other QoE or RVQoE reports to the SN, for different configurations (i.e., different measConfigAppLayerId), e.g. associated with different service types. For RVQoE reports, this may or may not depend on which node (the MN or the SN) that created the RVQoE configuration and/or sent the RVQoE configuration to the UE. As another option, the indication of which node to send QoE reports and/or RVQoE report to may apply to all QoE configurations and/or to all RVQoE configurations in the UE. With this option, the indication may be sent once to the UE, e.g. in an RRCReconfiguration message, instead of associating a separate indication with each QoE and/or RVQoE configuration.
The selection of the node and the order in which the reports shall be sent may depend on the RRC state of the UE was before being (re)configured to multi-connectivity operation.
   In one case, the UE can receive an indication in the configuration for QoE measurements that all QoE measurements and/or all RVQoE measurements which the UE may have collected while in RRC_INACTIVE state or RRC_IDLE state should always be sent to the MN.
   In one case, the UE can receive an indication in the configuration for QoE measurements that all QoE measurements and/or all RVQoE measurements which the UE may have collected while in RRC_INACTIVE state or in RRC_IDLE state should always be sent to the SN. In one case, the UE can receive an indication in the configuration for QoE measurements that all QoE measurements which the UE may have collected while in RRC_INACTIVE state or in RRC_IDLE state shall be sent to MN and all RVQoE measurements which the UE may have collected while in RRC_INACTIVE state or in RRC_IDLE state shall be sent to SN.
   In one case, the UE can receive an indication in the configuration for QoE measurements that all QoE/RVQoE measurements which the UE may have collected while in RRC_INACTIVE state shall be sent to one of the MN or the SN before sending all QoE/RVQoE measurements which the UE may have collected while in RRC_IDLE state.

The configuration of the node to which the reports are sent may be implicitly derived based on indications/configuration parameters received by the RAN node as part of QoE/RVQoE configuration from another network node (e.g., OAM or a CN node) where the indications/configuration parameters pertain to e.g. methods the RAN should use for the delivery of QoE reports, the need for MN or SN to perform alignment/correlation between RVQoE and radio measurements, and/or the need for another network node (e.g. MCE) to perform alignment/correlation between QoE and radio measurements.
In one case, the other network node (e.g., OAM or a CN node) can send an indication to the RAN (e.g., to the MN) indicating that QoE reports are to be delivered to MCE in a streaming fashion (e.g., indicating an MCE URI). or URL).).). The above indication can be implicitly used to indicate that the RAN node configuring the UE should indicate in the configuration for the UE that all the QoE reports shall be sent from the UE to the MN and not the SN (or vice versa).
In another case, the MN can receive from SN the indication that RVQoE measurements configured by SN are to be aligned with radio measurements that UE performs for SN and use this indication for requesting the UE (e.g., as part of RVQoE configuration) to send RVQoE measurements configured by SN to the SN.

### 3.1.2 Embodiments for the MN

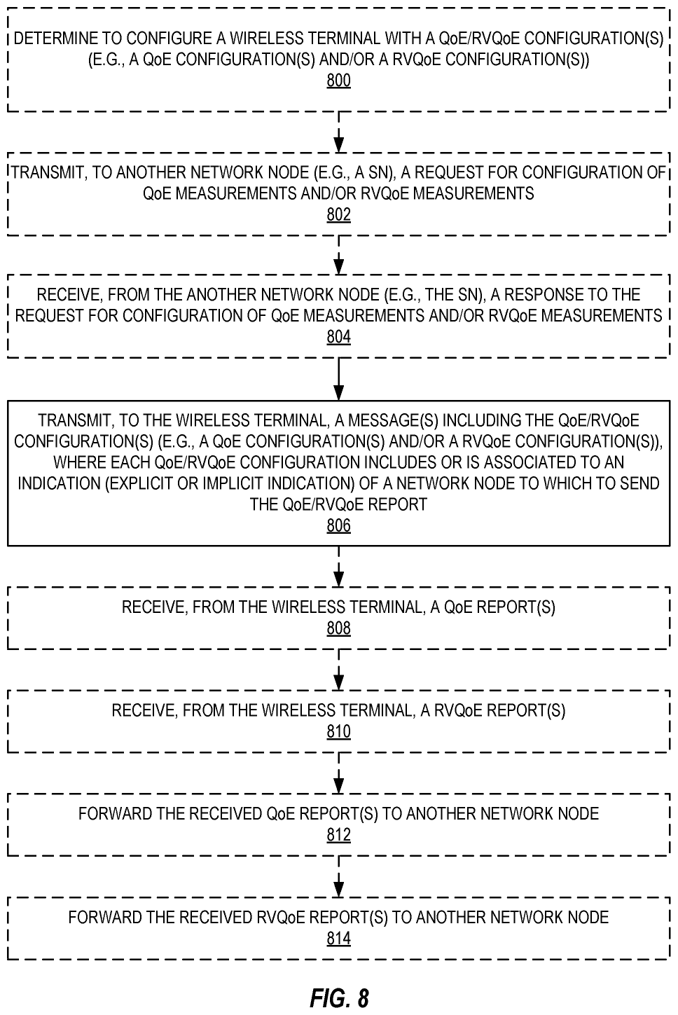

FIG. 8 illustrates the operation of a network node configured as a Master Node (MN) for a UE, for QoE measurement configuration and reporting, in accordance with one embodiment of the present disclosure. As illustrated, the procedure of FIG. 8 includes the following steps:
Step 800: The network node determines to configure the UE with QoE measurements and/or RVQoE measurements.
   Possibly additionally, or alternatively, receiving a request from an SN to configure QoE measurements or RVQoE measurements.
      The request may, e.g., be included in an S-NODE MODIFICATION REQUIRED message or in a new message (e.g., a new message dedicated to QoE/RVQoE coordination aspects between MN and SN for QoE/RVQoE configuration and/or reporting, such as a QOE CONFIGURATION REQUIRED XnAP message, or alike)
Step 802: Optionally, the network node transmits, to a Secondary Node (SN), a request for configuration of QoE measurements and/or a request for configuration of RVQoE measurements.
   The request may, e.g., be included in an S-NODE ADDITION REQUEST or S-NODE MODIFICATION REQUEST message or in a new message (e.g., a new message dedicated to QoE/RVQoE coordination aspects between MN and SN for QoE/RVQoE configuration and/or reporting, such as a QOE CONFIGURATION REQUEST XnAP message, or alike). In case of management-based QoE and RVQoE configuration, an existing or a newly defined non-UE-associated message can be used, containing the information and instructions pertaining to more than one UE.
   The initiation of the QoE measurements and the RVQoE measurements may be done by either the MN or the SN, or both nodes and with any combination of which node that initiated what type of measurement.
Step 804: Optionally (if the optional transmitting step above is performed), the network node receives, from the SN, a response to the request for configuration of QoE measurements and/or a response to the response to the request for configuration of RVQoE measurements.
   The request may, e.g., be included in an S-NODE ADDITION REQUEST ACKNOWLEDGE or S-NODE MODIFICATION REQUEST ACKNOWLEDGE message, or in a new message (e.g., a new message dedicated to QoE/RVQoE coordination aspects between MN and SN for QoE/RVQoE configuration and/or reporting, such as a QOE CONFIGURATION RESPONSE XnAP message, or alike). In case of management-based QoE and RVQoE configuration, an existing or a newly defined non-UE-associated message can be used, containing the information and instructions pertaining to more than one UE.
Step 806: The network node transmits one or multiple messages to a UE, e.g. RRCReconfiguration message(s), the message(s) comprising the configuration of QoE measurements and the configuration of RVQoE measurements and comprising, for each of the QoE measurement configuration and (possibly for each of) the RVQoE measurement configuration, an indication of the network node, to which the UE shall send the QoE and/or the RVQoE reports, respectively.
   The indication of the node may be an explicit or an implicit indication.
      An example of an explicit indication is an indication, indicating, e.g., the network node such as the MN or the SN, or in another option the SRB that the UE should use to send the reports.
      An implicit indication may, e.g., be the configuration of a certain SRB linked to the configuration of the QoE or RVQoE measurements. It could also be depending on in which part of the RRC message where the configuration is included, if the configuration is included in the MN part of the message, the UE shall send the reports to the MN, if the configuration is included in the SN part of the message, the UE shall send the reports to the SN.
      Alternatively, the indication may be an indication to the UE to send the QoE reports and/or the RVQoE reports respectively, to the node which carries the session in the application layer.
      For further examples of explicit or implicit indications, see UE embodiments above.
   The indication of the network node to which UE shall send the QoE reports and the RVQoE reports, respectively, may be the same node for QoE reports and RVQoE reports or it may be different nodes for QoE reports and RVQoE reports.
   The configuration of QoE measurements and the configuration of RVQoE measurements may be done in the same message or in different messages. The configuration of the indication to which node the UE shall transmit the reports may be sent together with the configuration of the QoE/RVQoE measurements, or separated from the configuration of the measurements.
   The message to the UE may be sent from the MN, from the SN or from both the MN and the SN.
   All the considerations related to the indication of where the UE should send the reports that are listed under UE embodiments are equally applicable for the MN as well, even if not listed here under the MN embodiments.
Step 808: Optionally, the network node receives QoE reports from the UE, if the MN was (explicitly, implicitly, or derivable) configured to receive QoE reports.
   The message containing the QoE report may be an MeasurementReportAppLayer message sent, e.g., on SRB4.
Step 810: Optionally, the network node receives RVQoE reports from the UE, if the MN was (explicitly, implicitly, or derivable) configured to receive QoE reports.
   The message containing the RVQoE report may be a MeasurementReportAppLayer message sent, e.g., on SRB4.
   If the MN was (explicitly, implicitly, or derivable) configured to receive both QoE reports and RVQoE reports, the QoE report and the RVQoE report may be received in the same message (e.g., a MeasurementReportAppLayer message) or in different messages (e.g., two separate MeasurementReportAppLayer messages).
Step 812: Optionally, if another node configured as a SN for the UE was (explicitly, implicitly or derivable) configured to receive QoE reports, and if the method for delivery of QoE reports from the UE to the SN is forwarding via the MN, the network node forwards the received QoE report to the other node configured as a SN.
   The QoE report may be forwarded to the SN as Information Element(s) on the XnAP level in an XnAP message.
   Alternatively, the MeasurementReportAppLayer RRC message containing the QoE report may be carried to the SN in an RRC TRANSFER XnAP message. In this case, the MN may, as one option, have received the MeasurementReportAppLayer RRC message containing the QoE report encapsulated in an ULInformationTransferMRDC RRC message.
Step 814: Optionally, if another node configured as a SN for the UE was (explicitly, implicitly or derivable) configured to receive RVQoE reports, and if the method for delivery of RVQoE reports from the UE to the SN is forwarding via the MN, the network node forwards the received RVQoE report to the other node configured as a SN.
   The RVQoE report may be forwarded to the SN as Information Element(s) on the XnAP level in an XnAP message.
   Alternatively, the MeasurementReportAppLayer RRC message containing the RVQoE report may be carried to the SN in an RRC TRANSFER XnAP message. In this case, the MN may, as one option, have received the MeasurementReportAppLayer RRC message containing the RVQoE report encapsulated in an ULInformationTransferMRDC RRC message.

### 3.1.3 Embodiments for the SN

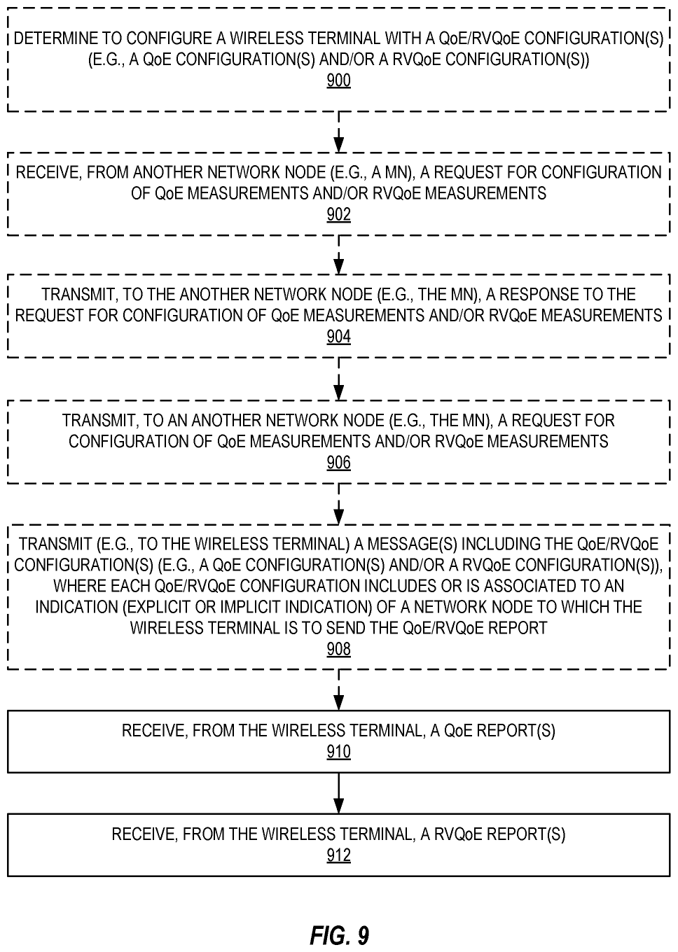

FIG. 9 illustrates the operation of a network node configured as a Secondary Node (SN) for a UE, for QoE measurement configuration and reporting, in accordance with an embodiment of the present disclosure. As illustrated, the procedure of FIG. 9 includes the following steps:
Step 900: Optionally, the network node determines to configure the UE with QoE measurements and/or RVQoE measurements.
Step 902: Optionally, additionally, or alternatively, the network node receives, from a Master Node (MN) of the UE, a request for configuration of QoE measurements and/or a request for configuration of RVQoE measurements.
   The request may, e.g., be included in an S-NODE ADDITION REQUEST or S-NODE MODIFICATION REQUEST message or in a new message (e.g., a new message dedicated to QoE/RVQoE coordination aspects between MN and SN for QoE/RVQoE configuration and/or reporting, such as a QOE CONFIGURATION REQUEST XnAP message, or alike). In case of management-based QoE and RVQoE configuration, an existing or a newly defined non-UE-associated message can be used, containing the information and instructions pertaining to more than one UE.
   The initiation of the QoE measurements and the RVQoE measurements may be done by either the MN or the SN, or both nodes and with any combination of which node that initiated what type of measurement.
Step 904: Optionally (if the above request for configuration of QoE measurements and/or a request for configuration of RVQoE measurements was/were received from the MN), the network node transmits, to the MN, a response to the request for configuration of QoE measurements and/or a response to the request for configuration of RVQoE measurements, wherein the response contains the requested QoE measurement configuration and/or the requested RVQoE measurement configuration
   The response may e.g. be included in an S-NODE ADDITION REQUEST ACKNOWLEDGE or S-NODE MODIFICATION REQUEST ACKNOWLEDGE message, or in a new message (e.g., a new message dedicated to QoE/RVQoE coordination aspects between MN and SN for QoE/RVQoE configuration and/or reporting, such as a QOE CONFIGURATION RESPONSE XnAP message, or alike). In case of management-based QoE and RVQoE configuration, an existing or a newly defined non-UE-associated message can be used, containing the information and instructions pertaining to more than one UE.
   If both a QoE configuration and a RVQoE configuration are sent to the MN, they may optionally be included in the same message, or, as another option, be included in two separate messages (e.g. if the request for a QoE configuration and the request for a RVQoE configuration were received in two separate messages from the MN.
Step 906: Optionally, alternatively, the network node transmits, to an MN, a request to configure QoE measurements or RVQoE measurements.
   The request may, e.g., be included in an S-NODE MODIFICATION REQUIRED message, or in a new message (e.g., a new message dedicated to QoE/RVQoE coordination aspects between MN and SN for QoE/RVQoE configuration and/or reporting, such as a QOE CONFIGURATION REQUIRED XnAP message, or alike). In case of management-based QoE and RVQoE configuration, an existing or a newly defined non-UE-associated message can be used, containing the information and instructions pertaining to more than one UE.
Step 908: Optionally, the network node transmits one or multiple messages to a UE, e.g. RRCReconfiguration, the message(s) comprising the configuration of QoE measurements and the configuration of RVQoE measurements and comprising an indication of the network node, to which the UE shall send the QoE and or the RVQoE reports, respectively.
   The indication of the node may be an explicit or an implicit indication.
      An example of an explicit indication is an indication, indicating, e.g., the network node such as the MN or the SN, or in another option the SRB that the UE should use to send the reports.
      An implicit indication may, e.g., be the configuration of a certain SRB linked to the configuration of the QoE or RVQoE measurements. It could also be depending on in which part of the RRC message where the configuration is included, if the configuration is included in the MN part of the message, the UE shall send the reports to the MN, if the configuration is included in the SN part of the message, the UE shall send the reports to the SN.
      Alternatively, the indication may be an indication to the UE to send the QoE reports and/or the RVQoE reports respectively, to the node which carries the session in the application layer.
      For further examples of explicit or implicit indications, see UE embodiments above.
   The indication of the network node to which UE shall send the QoE reports and the RVQoE reports, respectively, may be the same node for QoE reports and RVQoE reports or it may be different nodes for QoE reports and RVQoE reports.
   The configuration of QoE measurements and the configuration of RVQoE measurements may be done in the same message or in different messages. The configuration of the indication to which node the UE shall transmit the reports may be sent together with the configuration of the QoE/RVQoE measurements, or separated from the configuration of the measurements.
   The message to the UE may be sent from the MN, from the SN or from both the MN and the SN.
   All the considerations related to the indication of where the UE should send the reports that are listed under UE embodiments are equally applicable for the MN as well, even if not listed here under the MN embodiments.
Step 910: The network node receives QoE reports from a UE, if the SN was (explicitly, implicitly, or derivable) configured to receive QoE reports.
   The message containing the QoE report may be a MeasurementReportAppLayer message sent, e.g., on SRB3 or a new SRB5 configured towards the SN. Alternatively, the message may be an ULInformationTransferMRDC message with an embedded MeasurementReportAppLayer message, sent on SRB4 via the MN to the SN. That is, the MN receives the ULInformationTransferMRDC message on SRB4, extracts the MeasurementReportAppLayer message from the ULInformationTransferMRDC message and sends it to the SN encapsulated in an RRC TRANSFER XnAP message.
Step 912: The network node receives RVQoE reports from a UE, if the SN was (explicitly, implicitly, or derivable) configured to receive QoE reports.
   The message containing the QoE report may be a MeasurementReportAppLayer message sent, e.g., on SRB3 or a new SRB5 configured towards the SN. Alternatively, the message may be an ULInformationTransferMRDC message with an embedded MeasurementReportAppLayer message, sent on SRB4 via the MN to the SN. That is, the MN receives the ULInformationTransferMRDC message on SRB4, extracts the MeasurementReportAppLayer message from the ULInformationTransferMRDC message and sends it to the SN encapsulated in an RRC TRANSFER XnAP message.
      3.1.4 Special Case for m-Based QoE Configuration

Configuring a UE for QoE measurements and measurement reporting when both MN and SN receive the same m-based QoE configuration:
In one embodiment, it is up to the nodes (e.g., MN and SN) to decide by coordination which node should configure the UE for these QoE measurements. In one embodiment, the UE is allowed to send the QoE report(s) to either of the nodes.
In one embodiment, an indication is provided to the UE (e.g., from the MN and/or the SN) that the received QoE configuration is identical to both MN and SN
   e.g., the one that configured it for QoE measurements, or
   the one that did not configure the UE for these QoE measurements
In one embodiment, the node (e.g., the MN or SN) that did not configure QoE measurements, upon inter-node communication, may be enabled to configure the UE for the RVQoE measurements.
   As one option, the MN configures UE for the QoE measurements and indicates to the SN to configure the UE for the RVQoE measurements
   Another option, the SN configures the UE for the QoE measurements and indicates to the MN to configure the UE for the RVQoE measurements
In one embodiment, the node that did not configure the UE for the QoE and/or RVQoE measurements is enabled by the node that did, e.g., via some indication, to receive QoE and/or RVQoE measurement reports.

### 3.2 Example Implementations

3.2.1 Example where the UE's QoE/RVQoE Reporting Behavior is Controlled by QoE/RVQoE Configuration

An example implementation in 3GPP TS 38.331 of how configuration of a UE to transmit the QoE and RVQoE reports may look like this (using the AppLayerMeasConfig IE definition in section 6.3.4 of 3GPP TS 38.331 version 17.2.0 as the baseline):

### AppLayerMeasConfig

The IE AppLayerMeasConfig indicates configuration of application layer measurements.

### AppLayerMeasConfig Information Element

```
    -- ASN1START
    -- TAG-APPLAYERMEASCONFIG-START
```

| | |
|---|---|
| AppLayerMeasConfig-r17 ::= | SEQUENCE { |

```
        measConfigAppLayerToAddModList-r17 SEQUENCE (SIZE (1..maxNrofAppLayerMeas-
    r17)) OF MeasConfigAppLayer-r17 OPTIONAL, -- Need N
        measConfigAppLayerToReleaseList-r17 SEQUENCE (SIZE (1..maxNrofAppLayerMeas-
    r17)) OF MeasConfigAppLayerId-r17 OPTIONAL, -- Need N
```

| | |
|---|---|
| rrc-SegAllowed-r17 | ENUMERATED {enabled} |

```
    OPTIONAL, -- Need R
        ...
    }
```

| | |
|---|---|
| MeasConfigAppLayer-r17 ::= | SEQUENCE { |
| measConfigAppLayerId-r17 | MeasConfigAppLayerId-r17, |

```
        measConfigAppLayerContainer-r17 OCTET STRING (SIZE (1..8000))
    OPTIONAL, -- Need N
```

| | |
|---|---|
| serviceType-r17 | ENUMERATED {streaming, mtsi, vr, spare5, spare4, spare3, |

spare2, spare1} OPTIONAL, -- Need M

| | |
|---|---|
| pauseReporting-r17 | BOOLEAN |

```
    OPTIONAL, -- Need M
        transmissionOfSessionStartStop-r17 BOOLEAN
    OPTIONAL, -- Need M
```

| | |
|---|---|
| ran-VisibleParameters-r17 | SetupRelease {RAN-VisibleParameters-r17} |

```
    OPTIONAL, -- Cond serviceType
        ...,
      [[
```

| | |
|---|---|
| reportingCellGroupQoE-r18 | ENUMERATED {mcg, scg, sessionCG, spare1, |

spare2, spare3, spare4} OPTIONAL, -- Need M

| | |
|---|---|
| reportingCellGroupQoE-SDT-r18 | ENUMERATED {mcg, spare1, spare2, |

```
    spare3} OPTIONAL, -- Need M
      ]]
    }
```

| | |
|---|---|
| RAN-VisibleParameters-r17 ::= | SEQUENCE { |
| ran-VisiblePeriodicity-r17 | ENUMERATED {ms120, ms240, ms480, ms640, ms1024} |

```
    OPTIONAL, -- Need S
        numberOfBufferLevelEntries-r17 INTEGER (1..8)
    OPTIONAL, -- Need R
        reportPlayoutDelayForMediaStartup-r17 BOOLEAN
    OPTIONAL, -- Need M
        ...,
        [[
```

| | |
|---|---|
| reportingCellGroupRVQoE-r18 | ENUMERATED {mcg, scg, sessionCG, |

spare1, spare2, spare3,spare4} OPTIONAL, -- Need M

| | |
|---|---|
| reportingCellGroupRVQoE-SDT-r18 | ENUMERATED {mcg, spare1, spare2, |

```
    spare3} OPTIONAL, -- Need M
  ]]
}
-- TAG-APPLAYERMEASCONFIG-STOP
-- ASN1STOP
```

AppLayerMeasConfig field descriptions

measConfigAppLayerContainer
The field contains configuration of application layer measurements, see Annex L (normative) in TS
26.247 [68], clause 16.5 in TS 26.114 [69] and TS 26.118 [70].
pauseReporting
The field indicates whether the transmission of measReportAppLayerContainer is paused or not. Value
true indicates the transmission of measReportAppLayerContainer is paused; value false indicates the
transmission of measReportAppLayerContainer is not paused.
ran-VisibleParameters
The field indicates whether RAN visible application layer measurements shall be reported or not.
reportingCellGroupQoE
The field indicates to which network node the QoE reports shall be sent. Value mcg indicates that
the reports shall be sent to the MCG, value scg indicates that the reports shall be sent to the
SCG, the value sessionCG indicates that the reports shall be sent to the cell group which carries
the application session on which the measurements are performed.
reportingCellGroupQoE-SDT
The field indicates to which network node the QoE reports shall be sent when UE is in
RRC_INACTIVE state. Value mcg indicates that the QoE reports shall be sent to the MCG.
rrc-SegAllowed
This field indicates that RRC segmentation of MeasurementReportAppLayer is allowed. It may be
present only if the UE supports RRC segmentation of the MeasurementReportAppLayer message in
UL.
serviceType
Indicates the type of application layer measurement. Value streaming indicates Quality of Experience
Measurement Collection for streaming services (see TS 26.247 [68]), value mtsi indicates Quality of
Experience Measurement Collection for MTSI (see TS 26.114 [69]). value vr indicates Quality of
Experience Measurement Collection for VR service (see TS 26.118 [70]). The network always
configures serviceType when application layer measurements are initially configured and at fullConfig.
transmissionOfSessionStartStop
The field indicates whether the UE shall transmit indications when sessions in the application layer
start and stop. The UE transmits a session start indication upon configuration of this field if a session
already has started in the application layer.

RAN-VisibleParameters field descriptions

numberOfBufferLevelEntries
The field contains the maximum number of buffer level entries that can be reported for RAN visible
application layer measurements.
ran-VisiblePeriodicity
The field indicates the periodicity of RAN visible application layer measurements reporting. Value
ms120 indicates 120 ms, value ms240 indicates 240 ms and so on.
reportPlayoutDelayForMediaStartup
The field indicates whether the UE shall report Playout Delay for Media Startup for RAN visible
application layer measurements.
reportingCellGroupRVQoE
The field indicates to which network node the RVQoE reports shall be sent. Value mcg indicates
that the reports shall be sent to the MCG, value scg indicates that the reports shall be sent to the
SCG, the value sessionCG indicates that the reports shall be sent to the cell group which carries
the application session on which the measurements are performed.
reportingCellGroupRVQoE-SDT
The field indicates to which network node the RVQoE reports shall be sent when UE is in
RRC_INACTIVE state. Value mcg indicates that the RVQoE reports shall be sent to the MCG.

| Conditional Presence | Explanation |
|---|---|
| serviceType | This field is optionally present, need M, when serviceType is set to streaming |
| | or vr. Otherwise, it is absent. |

3.2.2 Example where the UE's QoE/RVQoE Reporting Behavior is Commonly Controlled for all QoE/RVQoE Configurations

The following is an example implementation in 3GPP TS 38.331 of configuration of a UE's QoE/RVQoE reporting behavior using the AppLayerMeasConfig IE definition in section 6.3.4 of 3GPP TS 38.331 version 17.2.0 as the baseline. In this example, the UE's reporting behavior in terms of which node to transmit the QoE/RVQoE reports to is commonly controlled for all QoE configurations (i.e., it applies to all QoE configurations) and commonly controlled for all RVQoE configurations (i.e., it applies to all RVQoE configurations).

### AppLayerMeasConfig

The IE AppLayerMeasConfig indicates configuration of application layer measurements.

### AppLayerMeasConfig Information Element

-- ASN1START
-- TAG-APPLAYERMEASCONFIG-START

| | |
|---|---|
| AppLayerMeasConfig-r17 ::= | SEQUENCE { |

```
  measConfigAppLayerToAddModList-r17 SEQUENCE (SIZE (1..maxNrofAppLayerMeas-
r17)) OF MeasConfig AppLayer-r17 OPTIONAL, -- Need N
  measConfigAppLayerToReleaseList-r17 SEQUENCE (SIZE (1..maxNrofAppLayerMeas-
r17)) OF MeasConfigAppLayerId-r17 OPTIONAL, -- Need N
```

| | |
|---|---|
| rrc-SegAllowed-r17 | ENUMERATED {enabled} OPTIONAL, -- Need R |
| reportingNodeQoE-r18 | ENUMERATED {mn, sn, sessionNode, spare4, spare3, |

spare2, spare1} OPTIONAL, -- Need M

| | |
|---|---|
| reportingNodeRVQoE-r18 | ENUMERATED {mn, sn, sessionNode, spare4, |

spare3, spare2, spare1} OPTIONAL, -- Need M
...
}

| | |
|---|---|
| MeasConfigAppLayer-r17 ::= | SEQUENCE { |
| measConfigAppLayerId-r17 | MeasConfigAppLayerId-r17, |

measConfigAppLayerContainer-r17 OCTET STRING (SIZE (1..8000))
OPTIONAL, -- Need N

| | |
|---|---|
| serviceType-r17 | ENUMERATED {streaming, mtsi, vr, spare5, spare4, spare3, |

spare2, spare1} OPTIONAL, -- Need M

| | |
|---|---|
| pauseReporting-r17 | BOOLEAN |

OPTIONAL, -- Need M
transmissionOfSessionStartStop-r17 BOOLEAN
OPTIONAL, -- Need M

| | |
|---|---|
| ran-VisibleParameters-r17 | SetupRelease {RAN-VisibleParameters-r17} |

OPTIONAL, -- Cond ServiceType
...
}

| | |
|---|---|
| RAN-VisibleParameters-r17 ::= | SEQUENCE { |
| ran-VisiblePeriodicity-r17 | ENUMERATED {ms120, ms240, ms480, ms640, ms1024} |

OPTIONAL, -- Need S

| | |
|---|---|
| numberOfBufferLevelEntries-r17 | INTEGER (1..8) |

```
OPTIONAL, -- Need R
  reportPlayoutDelayForMediaStartup-r17 BOOLEAN
OPTIONAL, -- Need M
  ...
}
-- TAG-APPLAYERMEASCONFIG-STOP
-- ASN1STOP
```

AppLayerMeasConfig field descriptions

measConfigAppLayerContainer
The field contains configuration of application layer measurements, see Annex L
(normative) in TS 26.247 [68], clause 16.5 in TS 26.114 [69] and TS 26.118 [70].
pauseReporting
The field indicates whether the transmission of measReportAppLayerContainer is paused or
not. Value true indicates the transmission of measReportAppLayerContainer is paused;
value false indicates the transmission of measReportAppLayerContainer is not paused.
ran-VisibleParameters
The field indicates whether RAN visible application layer measurements shall be reported
or not.
reportingNodeQoE
This field indicates the node the QoE reports should be sent to. It applies to all QoE
configurations in the UE. The value mn indicates the MN, the value sn indicates the
SN, and the value sessionNode indicates that the QoE reports should be sent to the
node carrying the data flow of the application session the QoE report pertains to.
reportingNodeRVQoE
This field indicates the node the RAN Visible QoE reports should be sent to. It applies
to all RAN Visible QoE configurations in the UE. The value mn indicates the MN, the
value sn indicates the SN and the value sessionNode indicates that the RAN Visible
QoE reports should be sent to the node carrying the data flow of the application
session the RAN Visible QoE report pertains to.
rrc-SegAllowed
This field indicates that RRC segmentation of MeasurementReportAppLayer is allowed. It
may be present only if the UE supports RRC segmentation of the
MeasurementReportAppLayer message in UL.
serviceType
Indicates the type of application layer measurement. Value streaming indicates Quality of
Experience Measurement Collection for streaming services (see TS 26.247 [68]), value mtsi
indicates Quality of Experience Measurement Collection for MTSI (see TS 26.114 [69]).
value vr indicates Quality of Experience Measurement Collection for VR service (see TS
26.118 [70]). The network always configures serviceType when application layer
measurements are initially configured and at fullConfig.
transmissionOfSessionStartStop
The field indicates whether the UE shall transmit indications when sessions in the
application layer start and stop. The UE transmits a session start indication upon
configuration of this field if a session already has started in the application layer.

RAN-VisibleParameters field descriptions

numberOfBufferLevelEntries
The field contains the maximum number of buffer level entries that can be reported for
RAN visible application layer measurements.
ran-VisiblePeriodicity
The field indicates the periodicity of RAN visible application layer measurements
reporting. Value ms120 indicates 120 ms, value ms240 indicates 240 ms and so on.
reportPlayoutDelayForMediaStartup
The field indicates whether the UE shall report Playout Delay for Media Startup for RAN
visible application layer measurements.

| Conditional Presence | Explanation |
|---|---|
| ServiceType | This field is optionally present, Need M, when |
| | serviceType is set to streaming or vr. |
| | Otherwise, it is |
| | absent. |

### 4 Further Description

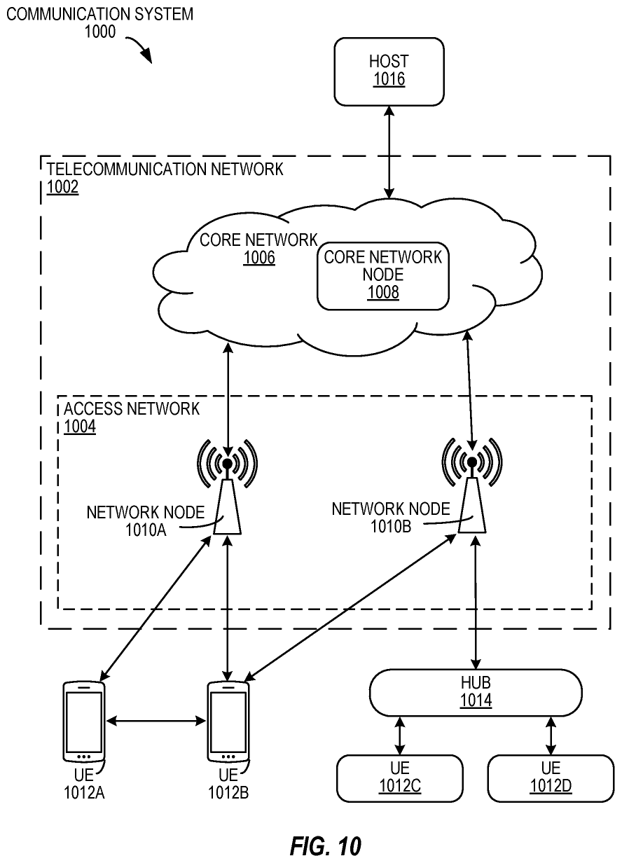

FIG. 10 shows an example of a communication system 1000 in accordance with some embodiments.

In the example, the communication system 1000 includes a telecommunication network 1002 that includes an access network 1004, such as a Radio Access Network (RAN), and a core network 1006, which includes one or more core network nodes 1008. The access network 1004 includes one or more access network nodes, such as network nodes 1010A and 1010B (one or more of which may be generally referred to as network nodes 1010), or any other similar Third Generation Partnership Project (3GPP) access node or non-3GPP Access Point (AP). The network nodes 1010 facilitate direct or indirect connection of User Equipment (UE), such as by connecting UEs 1012A, 1012B, 1012C, and 1012D (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system 1000 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1002 is a cellular network that implements 3GPP standardized features. Accordingly, the telecommunication network 1002 may support network slicing to provide different logical networks to different devices that are connected to the telecommunication network 1002. For example, the telecommunication network 1002 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR—Dual Connectivity (EN-DC).

In the example, a hub 1014 communicates with the access network 1004 to facilitate indirect communication between one or more UEs (e.g., UE 1012C and/or 1012D) and network nodes (e.g., network node 1010B). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a Virtual Reality (VR) headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010B. The hub 1014 may also allow for a different communication scheme and/or schedule between the hub 1014 and UEs (e.g., UE 1012C and/or 1012D), and between the hub 1014 and the core network 1006. In other examples, the hub 1014 is connected to the core network 1006 and/or one or more UEs via a wired connection. Moreover, the hub 1014 may be configured to connect to a Machine-to-Machine (M2M) service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010B. In other embodiments, the hub 1014 may be a non-dedicated hub—that is, a device which is capable of operating to route communications between the UEs and the network node 1010B, but which is additionally capable of operating as a communication start and/or end point for certain data channels.

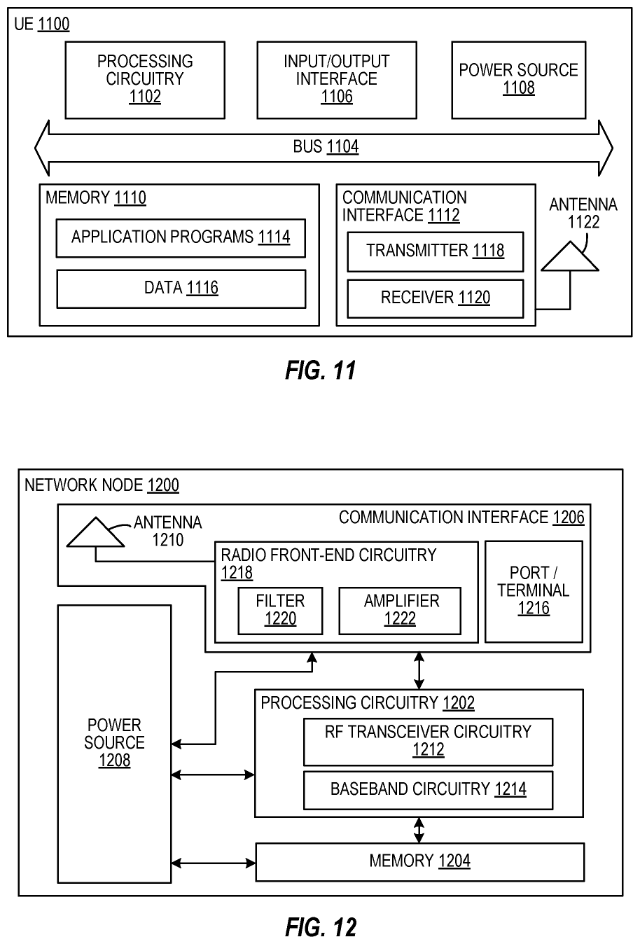

FIG. 11 shows a UE 1100 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1102 may include multiple Central Processing Units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging the power source 1108. Power circuitry may perform any formatting, converting, or other modification to the power from the power source 1108 to make the power suitable for the respective components of the UE 1100 to which power is supplied.

The memory 1110 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1110 may allow the UE 1100 to access instructions, application programs, and the like stored on transitory or non-transitory memory media, to off-load data, or to upload data. An article of manufacture, such as one utilizing a communication system, may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., the antenna 1122) and may share circuit components, software, or firmware, or alternatively be implemented separately.

In the illustrated embodiment, communication functions of the communication interface 1112 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1112, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 12 shows a network node 1200 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes processing circuitry 1202, memory 1204, a communication interface 1206, and a power source 1208. The network node 1200 may be composed of multiple physically separate components (e.g., a Node B component and an RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1200 may be configured to support multiple RATs. In such embodiments, some components may be duplicated (e.g., separate memory 1204 for different RATs) and some components may be reused (e.g., an antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1200.

The processing circuitry 1202 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1200 components, such as the memory 1204, to provide network node 1200 functionality.

In some embodiments, the processing circuitry 1202 includes a System on a Chip (SOC). In some embodiments, the processing circuitry 1202 includes one or more of Radio Frequency (RF) transceiver circuitry 1212 and baseband processing circuitry 1214. In some embodiments, the RF transceiver circuitry 1212 and the baseband processing circuitry 1214 may be on separate chips (or sets of chips), boards, or units, such as radio units and digital units. In alternative embodiments, part or all of the RF transceiver circuitry 1212 and the baseband processing circuitry 1214 may be on the same chip or set of chips, boards, or units.

The memory 1204 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and the memory 1204 are integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. The radio front-end circuitry 1218 comprises filters 1220 and amplifiers 1222. The radio front-end circuitry 1218 may be connected to the antenna 1210 and the processing circuitry 1202. The radio front-end circuitry 1218 may be configured to condition signals communicated between the antenna 1210 and the processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of the filters 1220 and/or the amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface 1206 may comprise different components and/or different combinations of components.

In certain alternative embodiments, the network node 1200 does not include separate radio front-end circuitry 1218; instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes the one or more ports or terminals 1216, the radio front-end circuitry 1218, and the RF transceiver circuitry 1212 as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, the communication interface 1206, and/or the processing circuitry 1202 may be configured to perform any receiving operations and/or certain obtaining operations described herein as being performed by the network node 1200. Any information, data, and/or signals may be received from a UE, another network node, and/or any other network equipment. Similarly, the antenna 1210, the communication interface 1206, and/or the processing circuitry 1202 may be configured to perform any transmitting operations described herein as being performed by the network node 1200. Any information, data, and/or signals may be transmitted to a UE, another network node, and/or any other network equipment.

The power source 1208 provides power to the various components of the network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid or an electricity outlet) via input circuitry or an interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

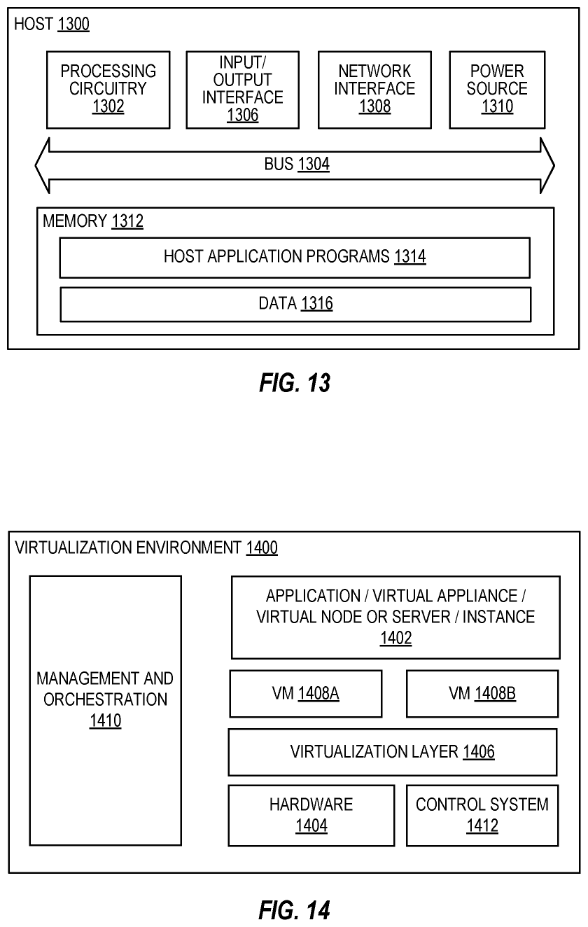

FIG. 13 is a block diagram of a host 1300, which may be an embodiment of the host 1016 of FIG. 10, in accordance with various aspects described herein. As used herein, the host 1300 may be or comprise various combinations of hardware and/or software including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and memory 1312. Other components may be included in other embodiments. Features of these components may be substantially similar to those described with respect to the devices of previous figures, such as FIGS. 11 and 12, such that the descriptions thereof are generally applicable to the corresponding components of the host 1300.

The memory 1312 may include one or more computer programs including one or more host application programs 1314 and data 1316, which may include user data, e.g. data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for Over-The-Top (OTT) services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or VM Monitors (VMMs)), provide VMs 1408A and 1408B (one or more of which may be generally referred to as VMs 1408), and/or perform any of the functions, features, and/or benefits described in relation with some embodiments described herein. The virtualization layer 1406 may present a virtual operating platform that appears like networking hardware to the VMs 1408.

The VMs 1408 comprise virtual processing, virtual memory, virtual networking, or interface and virtual storage, and may be run by a corresponding virtualization layer 1406. Different embodiments of the instance of a virtual appliance 1402 may be implemented on one or more of the VMs 1408, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1408 may be a software implementation of a physical machine that runs programs as if they were executing on a physical, non-virtualized machine. Each of the VMs 1408, and that part of the hardware 1404 that executes that VM, be it hardware dedicated to that VM and/or hardware shared by that VM with others of the VMs 1408, forms separate virtual network elements. Still in the context of NFV, a virtual network function is responsible for handling specific network functions that run in one or more VMs 1408 on top of the hardware 1404 and corresponds to the application 1402.

The hardware 1404 may be implemented in a standalone network node with generic or specific components. The hardware 1404 may implement some functions via virtualization. Alternatively, the hardware 1404 may be part of a larger cluster of hardware (e.g., such as in a data center or CPE) where many hardware nodes work together and are managed via management and orchestration 1410, which, among others, oversees lifecycle management of the applications 1402. In some embodiments, the hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1412 which may alternatively be used for communication between hardware nodes and radio units.

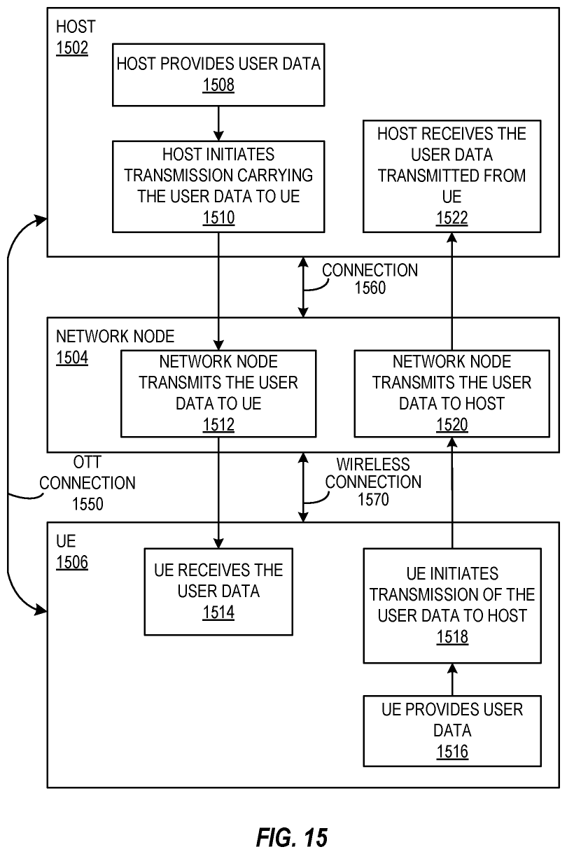

FIG. 15 shows a communication diagram of a host 1502 communicating via a network node 1504 with a UE 1506 over a partially wireless connection in accordance with some embodiments. Example implementations, in accordance with various embodiments, of the UE (such as the UE 1012A of FIG. 10 and/or the UE 1100 of FIG. 11), the network node (such as the network node 1010A of FIG. 10 and/or the network node 1200 of FIG. 12), and the host (such as the host 1016 of FIG. 10 and/or the host 1300 of FIG. 13) discussed in the preceding paragraphs will now be described with reference to FIG. 15.

Like the host 1300, embodiments of the host 1502 include hardware, such as a communication interface, processing circuitry, and memory. The host 1502 also includes software, which is stored in or is accessible by the host 1502 and executable by the processing circuitry. The software includes a host application that may be operable to provide a service to a remote user, such as the UE 1506 connecting via an OTT connection 1550 extending between the UE 1506 and the host 1502. In providing the service to the remote user, a host application may provide user data which is transmitted using the OTT connection 1550.

The network node 1504 includes hardware enabling it to communicate with the host 1502 and the UE 1506 via a connection 1560. The connection 1560 may be direct or pass through a core network (like the core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by the UE 1506 and executable by the UE's processing circuitry. The software includes a client application, such as a web browser or operator-specific “app” that may be operable to provide a service to a human or non-human user via the UE 1506 with the support of the host 1502. In the host 1502, an executing host application may communicate with the executing client application via the OTT connection 1550 terminating at the UE 1506 and the host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via the connection 1560 between the host 1502 and the network node 1504 and via a wireless connection 1570 between the network node 1504 and the UE 1506 to provide the connection between the host 1502 and the UE 1506. The connection 1560 and the wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504 in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR, or AR which it can broadcast, multicast, or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1550 between the host 1502 and the UE 1506 in response to variations in the measurement results. The measurement procedure and/or the network functionality for reconfiguring the OTT connection 1550 may be implemented in software and hardware of the host 1502 and/or the UE 1506. In some embodiments, sensors (not shown) may be deployed in or in association with other devices through which the OTT connection 1550 passes; the sensors may participate in the measurement procedure by supplying values of the monitored quantities exemplified above, or by supplying values of other physical quantities from which software may compute or estimate the monitored quantities. The reconfiguring of the OTT connection 1550 may include message format, retransmission settings, preferred routing, etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency, and the like by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### GROUP A EMBODIMENTS

Embodiment 1: A method performed by a User Equipment, UE, comprising one or more of the following:
receiving (700A, 700B-1), from one or more network nodes, one or more messages comprising one or more Quality of Experience, QoE, configurations and/or one or more Radio Access Network, RAN, visible QoE, RVQoE, configurations;
for each QoE configuration or commonly for the one or more QoE configurations, either receiving (700A) an indication that indicates a network node to which respective QoE reports are to be sent or determining (700B-2) the network node to which respective QoE reports are to be sent;
for each RVQoE configuration or commonly for the one or more RVQoE configurations, either receiving (700A) an indication that indicates a network node to which respective RVQoE reports are to be sent or determining (700B-2) the network node to which respective RVQoE reports are to be sent;
performing (702) QoE measurements and/or RVQoE measurements in accordance with the one or more QoE configurations and/or the one or more RVQoE configurations;
for each QoE report from among one or more QoE reports comprising results of the QoE measurements, transmitting (704-1) the QoE report to the indicated or determined network node to which the QoE report is to be sent; and
for each RVQoE report from among one or more RVQoE reports comprising results of the QoE measurements, transmitting (704-2) the RVQoE report to the indicated or determined network node to which the QoE report is to be sent.

Embodiment 2: The method of embodiment 1 wherein the network node to which QoE reports are to be sent for at least one of the one or more QoE configurations is different than the network node to which the RVQoE reports are to be sent for at least one of the one or more RVQoE configurations.

Embodiment 3: The method of embodiment 1 or 2 comprising, for each QoE configuration, receiving (700A) an indication that indicates a network node to which respective QoE reports are to be sent.

Embodiment 4: The method of embodiment 3 wherein, for each QoE configuration from among the one or more QoE configurations, the indication that indicates the network node to which respective QoE reports are to be sent is either comprised in the QoE configuration or in a message(s) that contains the QoE configuration.

Embodiment 5: The method of embodiment 1 or 2 comprising, commonly for all of the one or more QoE configurations, receiving (700A) an indication that indicates a common network node to which QoE reports are to be sent.

Embodiment 6: The method of embodiment 5 wherein the indication that indicates the common network node to which the QoE reports are to be sent is either comprised in at least one of the one or more QoE configurations or in a message(s) that contains at least one of the one or more QoE configurations.

Embodiment 7: The method of any of embodiments 1 to 6 comprising, for each RVQoE configuration, receiving (700A) an indication that indicates a network node to which respective RVQoE reports are to be sent.

Embodiment 8: The method of embodiment 7 wherein, for each RVQoE configuration from among the one or more RVQoE configurations, the indication that indicates the network node to which respective RVQoE reports are to be sent is either comprised in the RVQoE configuration or in a message(s) that contains the RVQoE configuration.

Embodiment 9: The method of any of embodiments 1 to 6 comprising, commonly for all of the one or more RVQoE configurations, receiving (700A) an indication that indicates a common network node to which respective RVQoE reports are to be sent.

Embodiment 10: The method of embodiment 9 wherein the indication that indicates the common network node to which the RVQoE reports are to be sent is either comprised in at least one of the one or more RVQoE configurations or in a message(s) that contains at least one of the one or more RVQoE configurations.

Embodiment 11: The method of any of embodiments 3 to 10 wherein each indication is any one of the following:
an indication of the network node (e.g., MN, SN),
an indication to send the report to the node that carries the data flow(s) of the application session the report pertains to;
an indication of a cell group (e.g., MCG, SCG);
an indication to send the report to the cell group that carries the data flow(s) of the application session the report pertains to;
an indication of the SRB to transmit on (e.g., SRB4 implies MN and SRB5 implies SN);
an indication that a MeasurementReportAppLayer message containing a certain report type should be included in a message (e.g., an ULInformationTransferMRDC RRC message) which is used for encapsulating a message to be forwarded from the MN to the SN (or vice versa);
absence of an indication can be an implicit indication that the report should be sent to the node that sent the configuration;
absence of an indication can be an implicit indication that the report should be sent to the node which handles the DRB(s) which carries/carry the data flow(s) of the application session the report pertains to;
absence of an indication can be an implicit indication that the UE can autonomously decide which node to send the report to.

Embodiment 12: The method of embodiment 1 or 2 comprising, for each QoE configuration, determining (700B-2) a network node to which respective QoE reports are to be sent.

Embodiment 13: The method of embodiment 1 or 2 comprising, commonly for all of the one or more QoE configurations, determining (700B-2) a common network node to which QoE reports are to be sent.

Embodiment 14: The method of embodiment 1, 2, 12, or 13 comprising, for each RVQoE configuration, determining (700B-2) a network node to which respective RVQoE reports are to be sent.

Embodiment 15: The method of embodiment 1, 2, 12, or 13 comprising, commonly for all of the one or more RVQoE configurations, determining (700B-2) a common network node to which RVQoE reports are to be sent.

Embodiment 16: The method of any of the previous embodiments, further comprising: providing user data; and forwarding the user data to a host via the transmission to the network node.

### GROUP B EMBODIMENTS

Embodiment 17: A method performed by a first network node (e.g., a MN), the method comprising one or more of the following:
transmitting (806), to a User Equipment (UE), one or more messages comprising one or more Quality of Experience, QoE, configurations and/or one or more Radio Access Network, RAN, visible QoE, RVQoE, configurations and:
   for each QoE configuration or commonly for the one or more QoE configurations, an indication that indicates a network node to which respective QoE reports are to be sent;
   for each RVQoE configuration or commonly for the one or more RVQoE configurations, an indication that indicates a network node to which respective RVQoE reports are to be sent.

Embodiment 18: The method of embodiment 17 wherein the network node to which QoE reports are to be sent for at least one of the one or more QoE configurations is different than the network node to which the RVQoE reports are to be sent for at least one of the one or more RVQoE configurations.

Embodiment 19: A method performed by a second network node (e.g., a SN), the method comprising one or more of the following:
receiving (910), from a User Equipment (UE), one or more messages comprising one or more Quality of Experience, QoE, reports associated to one or more QoE configurations and/or one or more Radio Access Network, RAN, visible QoE, RVQoE, reports associated to one or more RVQoE configurations, wherein:
   for each QoE configuration or commonly for the one or more QoE configurations, the UE is either configured with or determines a network node to which respective QoE reports are to be sent;
   for each RVQoE configuration or commonly for the one or more RVQoE configurations, the UE is either configured with or determines a network node to which respective RVQoE reports are to be sent.

Embodiment 20: The method of embodiment 19 wherein the network node to which QoE reports are to be sent for at least one of the one or more QoE configurations is different than the network node to which the RVQoE reports are to be sent for at least one of the one or more RVQoE configurations.

Embodiment 21: The method of any of the previous embodiments, further comprising: obtaining user data; and forwarding the user data to a host or a user equipment.

### GROUP C EMBODIMENTS

Embodiment 22: A user equipment comprising: processing circuitry configured to perform any of the steps of any of the Group A embodiments; and power supply circuitry configured to supply power to the processing circuitry.

Embodiment 23: A network node comprising: processing circuitry configured to perform any of the steps of any of the Group B embodiments; and power supply circuitry configured to supply power to the processing circuitry.

Embodiment 24: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 25: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 26: The host of the previous embodiment, wherein the cellular network further includes a network node configured to communicate with the UE to transmit the user data to the UE from the host.

Embodiment 27: The host of the previous 2 embodiments, wherein: the processing circuitry of the host is configured to execute a host application, thereby providing the user data; and the host application is configured to interact with a client application executing on the UE, the client application being associated with the host application.

Embodiment 28: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 29: The method of the previous embodiment, further comprising: at the host, executing a host application associated with a client application executing on the UE to receive the user data from the UE.

Embodiment 30: The method of the previous embodiment, further comprising: at the host, transmitting input data to the client application executing on the UE, the input data being provided by executing the host application, wherein the user data is provided by the client application in response to the input data from the host application.

Embodiment 31: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 32: The host of the previous embodiment, wherein the cellular network further includes a network node configured to communicate with the UE to transmit the user data from the UE to the host.

Embodiment 33: The host of the previous 2 embodiments, wherein: the processing circuitry of the host is configured to execute a host application, thereby providing the user data; and the host application is configured to interact with a client application executing on the UE, the client application being associated with the host application.

Embodiment 34: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 35: The method of the previous embodiment, further comprising: at the host, executing a host application associated with a client application executing on the UE to receive the user data from the UE.

Embodiment 36: The method of the previous embodiment, further comprising: at the host, transmitting input data to the client application executing on the UE, the input data being provided by executing the host application, wherein the user data is provided by the client application in response to the input data from the host application.

Embodiment 37: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 38: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 39: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 40: The method of the previous embodiment, further comprising, at the network node, transmitting the user data provided by the host for the UE.

Embodiment 41: The method of any of the previous 2 embodiments, wherein the user data is provided at the host by executing a host application that interacts with a client application executing on the UE, the client application being associated with the host application.

Embodiment 42: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 43: The communication system of the previous embodiment, further comprising: the network node; and/or the user equipment.

Embodiment 44: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 45: The host of the previous 2 embodiments, wherein: the processing circuitry of the host is configured to execute a host application, thereby providing the user data; and the host application is configured to interact with a client application executing on the UE, the client application being associated with the host application.

Embodiment 46: The host of the any of the previous 2 embodiments, wherein the initiating receipt of the user data comprises requesting the user data.

Embodiment 47: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 48: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UV) comprising:
receiving, from a network node, one or more messages comprising a Quality of Experience (QoE) configuration and a Radio Access Network (RAN) visible QoE (RVQoE) configuration;
wherein the QoE configuration comprises an indication indicating a first signaling radio bearer, SRB, to use for reporting QoE measurements; and
wherein the RVQoE configuration comprises an indication indicating a second signaling radio bearer, SRB, to use for reporting RVQoE measurements;
performing QoE measurements and RVQoE measurements in accordance with the QoE configuration and RVQoE configuration, respectively;
transmitting a QoE report comprising QoE measurement results using the SRB indicated for reporting the QoE measurements; and
transmitting a RVQoE report comprising RVQoE measurements using the SRB indicated for reporting RVQoE measurements.

2. The method of claim 41, wherein the network node to which QoE reports are to be sent is different than the network node to which the RVQoE reports are to be sent.

3. (canceled)

4. The method of claim 41, wherein the indication that indicates the network node to which respective QoE reports are to be sent is either comprised in the QoE configuration or in a message(s) that can contain the QoE configuration.

5.-9. (canceled)

10. The method of claim 41 wherein the indication that indicates the network node to which respective QoE reports are to be sent is an indication that a MeasurementReportAppLayer message containing a certain report type should be included in a message which is used for encapsulating a message to be forwarded from the MN to the SN or vice versa.

11.-17. (canceled)

18. The method of claim 41, wherein the indication that indicates the common network node to which the QoE reports are to be sent is an indication that a MeasurementReportAppLayer message containing a certain report type should be included in a message which is used for encapsulating a message to be forwarded from the MN to the SN or vice versa.

19.-28. (canceled)

29. The method of claim 41, wherein the indication that indicates the common network node to which the RVQoE reports are to be sent is an indication that a MeasurementReportAppLayer message containing a certain report type should be included in a message which is used for encapsulating a message to be forwarded from the MN to the SN or vice versa.

30. (canceled)

31. A User Equipment (UE) adapted to:
receive, from a network node, one or more messages comprising a Quality of Experience (QoE), configuration and a Radio Access Network (RAN) visible QoE (RVQoE) configuration;
wherein the QoE configuration comprises an indication indicating a first signaling radio bearer (SRB) to use for reporting QoE measurements; and
wherein the RVQoE configuration comprises an indication indicating a second signaling radio bearer (SRB to use for reporting RVQoE measurements;
perform QoE measurement and RVQoE measurements in accordance with the QoE configuration and the RVQoE configurations, respectively;
transmit a QoE report comprising QoE measurement results using the first SRB indicated for reporting the QoE measurements; and
transmit a RVQoE report comprising RVQoE measurements using the second SRB indicated for reporting RVQoE measurements.

32. (canceled)

33. A User Equipment (UE) comprising:
a communication interface; and
processing circuitry associated with the communication interface, the processing circuitry configured to cause the UE to:
receive, from a network node, one or more messages comprising a Quality of Experience (QoE) configuration and a Radio Access Network (RAN) visible QoE (RVQoE) configuration;
wherein the QoE configuration comprises an indication indicating a first signaling radio bearer, SRB, to use for reporting QoE measurements; and
wherein the RVQoE configuration comprises an indication indicating a second signaling radio bearer (SRB) to use for reporting RVQoE measurements;
perform QoE measurements and RVQoE measurements in accordance with the QoE configuration and the RVQoE configurations, respectively;
transmit a QoE report comprising QoE measurements results using the SRB indicated for reporting the QoE measurements; and
transmit a RVQoE report comprising RVQoE measurements using the SRB indicated for reporting RVQoE measurements.

34. (canceled)

35. A method performed by a first network node, the method comprising:
transmitting, to a User Equipment (UE), one or more messages comprising one or more Quality of Experience (QoE) configurations and one or more Radio Access Network (RAN) visible QoE (RVQoE) configurations, wherein:
for each QoE configuration or commonly for the one or more QoE configurations, an indication that indicates a network node to which respective QoE reports are to be sent; and
for each RVQoE configuration or commonly for the one or more RVQoE configurations, an indication that indicates a network node to which respective RVQoE reports are to be sent.

36. The method of claim 35, wherein the network node to which QoE reports are to be sent for at least one of the one or more QoE configurations is different than the network node to which the RVQoE reports are to be sent for at least one of the one or more RVQoE configurations.

37. A method performed by a second network node, the method comprising:
receiving, from a User Equipment (UE), one or more messages comprising one or more Quality of Experience (QoE), reports associated to one or more QoE configurations and one or more Radio Access Network (RAN) visible QoE (RVQoE) reports associated to one or more RVQoE configurations, wherein:
for each QoE configuration or commonly for the one or more QoE configurations, the UE is either configured with or determines a network node to which respective QoE reports are to be sent; and
for each RVQoE configuration or commonly for the one or more RVQoE configurations, the UE is either configured with or determines a network node to which respective RVQoE reports are to be sent.

38. The method of claim 37, wherein the network node to which QoE reports are to be sent for at least one of the one or more QoE configurations is different than the network node to which the RVQoE reports are to be sent for at least one of the one or more RVQoE configurations.

39. The method of claim 1, wherein the first SRB and the second SRB are different.

40. The method of claim 1, wherein the first SRB and the second SRB are the same.

41. The method of claim 1, wherein the indication of the first signaling radio bearer indicates a first node to which the QoE measurements are to be sent; and
wherein the indication of the second signaling radio bearer indicates a second node to which the RVQoE measurements are to be sent.

42. The method of claim 1, wherein the QoE configuration does not comprise an indication indicating an SRB to use for reporting QoE measurements, and the method further comprises transmitting a QoE report comprising QoE measurement results using SRB4.

43. The method of claim 1, wherein the RVQoE configuration does not comprise an indication indicating an SRB to use for reporting RVQoE measurements, and the method further comprises transmitting a RVQoE report comprising RVQoE measurements using SRB4.

44. The UE of claim 33, wherein the first SRB and the second SRB are different.

45. The UE of claim 33, wherein the first SRB and the second SRB are the same.

46. The UE of claim 33, wherein the indication of the first signaling radio bearer indicates a first node to which the QoE measurements are to be sent; and wherein the indication of the second signaling radio bearer indicates a second node to which the RVQoE measurements are to be sent.

47. The UE of claim 33, wherein the QoE configuration does not comprise an indication indicating an SRB to use for reporting QoE measurements, and the UE transmit a QoE report comprising QoE measurement results using SRB4.

48. The UE of claim 33, wherein the RVQoE configuration does not comprise an indication indicating an SRB to use for reporting RVQoE measurements, and the UE transmits a RVQoE report comprising RVQoE measurements using SRB4.
